(19) United States
(12) Patent Application Publication
(10) Pub. No.: US 2024/0170811 A1
(43) Pub. Date: May 23, 2024

(54) BATTERY CELL APPARATUS

(71) Applicant: Rivian IP Holdings, LLC, Plymouth, MI (US)

(72) Inventors: Dapeng Wang, Irvine, CA (US); Brian Christopher Sisk, Dove Canyon, CA (US)

(73) Assignee: Rivian IP Holdings, LLC, Plymouth, MI (US)

(21) Appl. No.: 18/057,365

(22) Filed: Nov. 21, 2022

(51) Int. Cl. H01M 50/54; H01M 50/103; H01M 50/105; H01M 50/176; H01M 50/178; H01M 50/209; H01M 50/211; H01M 50/249; H01M 50/533; H01M 50/543

(52) U.S. Cl. CPC H01M 50/54; H01M 50/103; H01M 50/105; H01M 50/176; H01M 50/178; H01M 50/209; H01M 50/211; H01M 50/249; H01M 50/533; H01M 50/543; H01M 2220/20

(57) ABSTRACT

A battery cell apparatus can include a first electrode layer stack positioned within a housing, a first tab of the first electrode layer stack, a second tab of the first electrode layer stack coupled with a first terminal. The battery cell apparatus can include a second electrode layer stack positioned within the housing and a first tab of the second electrode layer stack coupled with the first tab of the first electrode layer stack. The first electrode layer stack can be electrically insulated from the second electrode layer stack.

### INTRODUCTION

Vehicles can use electricity to power a motor. Electricity can be provided by a battery to operate the vehicle or components thereof.

### SUMMARY

The present disclosure is related to a battery cell apparatus and related systems and methods. The battery cell apparatus can include multiple electrode layer stacks (e.g., jelly rolls from winding electrode layers or a battery cell stack from stacking or Z-folding electrode layers). For example, the battery cell apparatus can include two electrode layer stacks or more than two electrode layer stacks (e.g., three, four, ten, or some other number of electrode layer stacks). The battery cell can be a high voltage battery cell having an average operational voltage of 4V or greater. For example, the battery cell can have an average operational voltage that is two or more times greater than the average operational voltage of a battery cell apparatus having only a single electrode layer stack. The battery cell apparatus can include two or more electrode layer stacks that are electrically coupled in a series configuration. The two or more electrode layer stacks can be electrically insulated from each other and electrically insulated from a housing of the battery cell apparatus. Each of the electrode layer stacks can include at least two tabs. A tab can be single tab (e.g., a foil extending from one electrode layer to electrically couple the electrode layer with another electrode layer or other object) or a group of tabs (e.g., multiple foils from multiple electrode layers coupled together to form a single tab). As discussed herein, each tab can have a polarity. For example, a first tab can include multiple foils, where the first tab includes a positive polarity. A second tab can include multiple foils, where the second tab can have a negative polarity. The first electrode layer stack can be coupled with a tab of a second electrode layer stack via a connector. The connector can be a bimetallic connector. An insulative member can be positioned between the connector and the first electrode layer stack and between the connector and the second electrode layer stack. The insulative member can include a plurality of slots to receive a tab of the first electrode layer stack and a tab of the second electrode layer stack to relieve tension on the tabs. A tab of a first electrode layer stack can be coupled with a terminal of the battery cell apparatus. A tab of a second electrode layer stack can be coupled with a second terminal of the battery cell apparatus. A tab of the second electrode layer stack can be coupled with a first tab of a third electrode layer stack.

At least one aspect is directed to a battery cell apparatus. The battery cell apparatus can include a first electrode layer stack positioned within a housing, a first tab of the first electrode layer stack, a second tab of the first electrode layer stack coupled with a first terminal. The battery cell apparatus can include a second electrode layer stack positioned within the housing and a first tab of the second electrode layer stack coupled with the first tab of the first electrode layer stack. The first electrode layer stack can be electrically insulated from the second electrode layer stack.

At least one aspect is directed to a method. The method can include providing a housing of a battery cell, the housing defining a cavity. The method can include coupling a first tab of a first electrode layer stack with a first tab of a second electrode layer stack. The method can include coupling a second tab of the first electrode layer stack with a first terminal of the battery cell. The method can include coupling a second tab of the second electrode layer stack with a second terminal or with a first tab of a third electrode layer stack. The method can include providing the first electrode layer stack and the second electrode layer stack within the cavity.

At least one aspect is directed to a battery pack. The battery pack can include a plurality of battery cells. At least one of the plurality of battery cells can include a first electrode layer stack positioned within a housing, a first tab of the first electrode layer stack, a second tab of the first electrode layer stack coupled with a first terminal. The at least one of the plurality of battery cells can include a second electrode layer stack positioned within the housing, and a first tab of the second electrode layer stack coupled with the first tab of the first electrode layer stack. The first electrode layer stack can be electrically insulated from the second electrode layer stack.

At least one aspect is directed to an electric vehicle. The electric vehicle can include a battery cell. The battery cell can include a first electrode layer stack positioned within a housing, a first tab of the first electrode layer stack, a second tab of the first electrode layer stack coupled with a first terminal. The battery cell can include a second electrode layer stack positioned within the housing and a first tab of the second electrode layer stack coupled with the first tab of the first electrode layer stack. The first electrode layer stack can be electrically insulated from the second electrode layer stack.

At least one aspect is directed to a method of providing a battery cell. The method can include providing a battery cell, the battery cell including a first electrode layer stack positioned within a housing, a first tab of the first electrode layer stack, a second tab of the first electrode layer stack coupled with a first terminal. The battery cell including a second electrode layer stack positioned within the housing and a first tab of the second electrode layer stack coupled with the first tab of the first electrode layer stack. The first electrode layer stack can be electrically insulated from the second electrode layer stack.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example battery cell apparatus, in accordance with some aspects.

FIG. 2 depicts an example battery cell apparatus, in accordance with some aspects.

FIG. 3 depicts an example battery cell apparatus, in accordance with some aspects.

FIG. 4 depicts an example connector for a battery cell apparatus, in accordance with some aspects.

FIG. 5 depicts an example connector for a battery cell apparatus, in accordance with some aspects.

FIG. 6 depicts an example battery cell apparatus, in accordance with some aspects.

FIG. 7 depicts an example battery cell apparatus, in accordance with some aspects.

FIG. 8 depicts an example insulative member of a battery cell apparatus, in accordance with some aspects.

FIG. 9 depicts an example insulative member of a battery cell apparatus, in accordance with some aspects.

FIG. 10 depicts an example insulative member of a battery cell apparatus, in accordance with some aspects.

FIG. 11 is a flow diagram of an example method of assembling a battery cell apparatus, in accordance with some aspects.

FIG. 12 depicts an example electric vehicle, in accordance with some aspects.

FIG. 13 depicts an example battery pack, in accordance with some aspects.

FIG. 14 depicts battery module, in accordance with some aspects.

FIG. 15 is a flow diagram of an example method of providing a battery cell apparatus, in accordance with some aspects.

### DETAILED DESCRIPTION

Following below are more detailed descriptions of various concepts related to, and implementations of a battery cell apparatus and related systems and methods. The various concepts introduced above and discussed in greater detail below may be implemented in any of numerous ways.

The present disclosure is directed to a battery cell apparatus and related methods. More particularly, the present disclosure is directed to a battery cell including multiple electrode layer stacks (e.g., a jelly roll from winding electrode layers or a battery cell stack from stacking or Z-folding electrode layers), where the battery cell can have an average operational voltage (e.g., 4V or greater) that is higher than that of conventional battery cells (e.g., 3.2-3.65V). The battery cell can include two electrode layer stacks or more than two electrode layer stacks (e.g., three, four, ten, or some other number of electrode layer stacks). For example, the battery cell can include multiple electrode layer stacks that are electrically coupled together in a series orientation. The increased voltage of the battery cell can facilitate a DC fast charging of the battery cell (and a battery module or battery pack comprising at least one battery cell). The battery cell can include multiple electrode layer stacks can more efficiently optimize space within a battery pack including multiple battery cells, where each battery cell includes a battery cell housing. For example, if the number of electrode layer stacks in a battery pack or battery module remains constant, but the number of electrode layer stacks per battery cell housing increases, the number of required battery cell housings decreases, which can decrease the mass and volume of the battery pack or battery module that is occupied by battery housings, for example.

The disclosed solutions have a technical advantage of providing a battery cell having an increased voltage relative to a conventional battery cell, thereby allowing for high-voltage (e.g., 800V or greater) pack applications with fewer battery cells. For example, the battery cell can have an operational voltage of 6.4V-10.95V or greater, while a conventional battery cell having only one electrode layer stack can have an average operational voltage of 3.2V-3.65V. Using battery cells having an average operational voltage of approximately 3.65V, for example, a battery pack can achieve a nominal voltage of at least 800V to facilitate higher power DC fast charging or other high voltage applications with 220 cells per pack. With the battery cell of the present disclosure, namely a battery cell having multiple electrode layer stacks coupled in series to achieve an average operational voltage of 6.4V or greater, only 110 battery cells (or fewer) are required to achieve a nominal battery pack voltage of 800V or more. Fewer battery cells having multiple electrode layer stacks are required to suit a high voltage (e.g., greater than 800V) application than if conventional cells are used.

The battery cell can include two or more electrode layer stacks within a single battery cell housing. For example, the battery cell can include two or more electrode layer stacks that are electrically coupled in series and positioned within a single cavity of a single battery cell housing. Each electrode layer stack can be electrically coupled to at least one other electrode layer stack. For example, each electrode layer stack can include a positive tab (e.g., a positive terminal) and a negative tab (e.g., a negative terminal), where at least one of the positive or negative tabs can be electrically coupled to a negative or positive tab of another electrode layer stack of the battery cell. The battery cell can include a positive cell terminal and a negative cell terminal, where each terminal is accessible from an exterior of the battery cell (e.g., to electrically couple one cell to another). A positive tab of a first electrode layer stack can be electrically coupled with the positive cell terminal of the battery cell. A negative tab of a second electrode layer stack can be electrically coupled with the negative cell terminal of the battery cell. The negative tab of the first electrode layer stack can be electrically coupled with the positive tab of the second electrode layer stack. The battery cell can include three or more electrode layer stacks. For example, the battery cell can include a first electrode layer stack having a positive tab coupled with a positive terminal of the battery cell and a negative tab coupled with a positive tab of a second electrode layer stack. The second electrode layer stack can include a negative tab coupled with a positive tab of a third electrode layer stack. The third electrode layer stack can include a negative tab coupled with a negative terminal of the battery cell.

The electrode layer stacks can be coupled with other electrode layer stacks via a connector. For example, a positive tab of a first electrode layer stack can be coupled with a negative tab of a second electrode stack via a connector. The connector can be a bimetallic connector. The connector can be a busbar connector. The connector can be a bimetallic connector including a first portion having a first material composition and a second portion having a second material composition, where the first portion can be coupled with the second portion to form the connector. For example, the first portion can include a plurality of teeth (e.g., protrusions, projections, outwardly-extending members) or grooves (e.g., depression, indent, notch) to interact with a plurality of grooves or teeth of the second portion. An electrical conductivity of the first portion can be substantially similar to (e.g., ±95% similar to) a conductivity of the second portion. The first portion can have a different form factor (e.g., size or shape) than the second portion. The first portion can be mechanically coupled with the second portion via interaction of the teeth of the first portion with the grooves of the second portion, for example.

Each of the electrode layer stacks can be electrically insulated. For example, each electrode layer stack can be insulated from each of the other electrode layer stacks within the battery cell. Each electrode layer stack can be insulated from each of the other electrode layer stacks with a positive or negative terminal of each electrode layer stack electrically coupled with a negative or positive terminal of another electrode layer stack. For example, a tab of a first electrode layer stack can make an electrical connection with a tab of a second electrode layer stack or a terminal of the battery cell while the rest of the electrode layer stack (e.g., the stacked electrode layers and current collector foil that is not a part of the tab) can be insulated from the battery cell and other electrode layer stacks. The battery cell can include an insulating enclosure, such as a bag or pouch for each electrode layer stack. For example, the battery cell can include a first insulative pouch for a first electrode layer stack and a second insulative pouch for a second electrode layer stack. The battery cell can include insulative material positioned between the electrode layer stacks (e.g., between an insulative pouch containing the electrode layer stack) and an interior wall of the battery cell housing. The insulative material can electrically insulate the electrode layer stack from the battery cell housing such that the battery cell housing can remain electrically neutral. The battery cell can include an insulative material positioned adjacent to a sidewall of the housing, adjacent to a first wall (e.g., a top wall) of the housing, or adjacent to a second wall (e.g., a bottom wall) of the housing. For example, the battery cell can include an insulative member positioned adjacent the bottom wall of the housing. The insulative member can define a plurality of slots (e.g., openings, channels, slits) extending through the insulative member. The slots can receive the tab of an electrode layer stack. The electrode layer tab can be woven (e.g., snaked, laced, fed) through a plurality of slots. For example, the tab can be inserted into a first slot in a first direction, inserted into a second slot in a second direction, inserted into a third slot in the first direction, and coupled with a tab of another electrode layer stack. The slots of the insulative member can reduce a tensile force on the tab of an electrode layer stack to prevent the tab from being torn, damaged, or disconnected from another tab or terminal as the battery cell moves (e.g., during operation of an electric vehicle).

The battery cell 100 can include a housing 115. For example, the housing 115 can define a cavity 120. The cavity 120 can receive at least one electrode layer stack (e.g., a jelly roll from winding electrode layers or a battery cell stack from stacking or Z-folding electrode layers), such as a first electrode layer stack 140, a second electrode layer stack 170, a third electrode layer stack 700, or some other electrode layer stack. The housing 115 can enclose at least one electrode layer stack within the cavity 120. The housing can include a rigid or semi-rigid outer structure. For example, the housing 115 can include a rigid form factor such that the housing 115 retains its shape or is not easily deformed. The housing 115 can include a prismatic or rectangular form factor. For example, the housing 115 can include at least one first wall 125, at least one second wall 130, and at last least one sidewall 135. For example, the first wall 125 can be a top or a bottom of the housing 115, based on a particular orientation of the housing 115 in space. The second wall 130 can be opposite the first wall 125. For example, the second wall 130 can be a bottom or top of the housing 115. The housing can include the sidewall 135 positioned between the first wall 125 and the second wall 130. The housing can include the first wall 125 adjacent to or coupled with the second wall 130.

The housing 115 of the battery cell 100 can include one or more materials with various electrical conductivity or thermal conductivity, or a combination thereof. The electrically conductive and thermally conductive material for the housing 115 of the battery cell 100 can include a metallic material, such as aluminum, an aluminum alloy with copper, silicon, tin, magnesium, manganese, or zinc (e.g., aluminum 1000, 4000, or 5000 series), iron, an iron-carbon alloy (e.g., steel), silver, nickel, copper, and a copper alloy, among others. The electrically insulative and thermally conductive material for the housing 115 of the battery cell 100 can include a ceramic material (e.g., silicon nitride, silicon carbide, titanium carbide, zirconium dioxide, beryllium oxide, and among others) and a thermoplastic material (e.g., polyethylene, polypropylene, polystyrene, polyvinyl chloride, or nylon), among others. In examples where the housing 115 of the battery cell 100 is prismatic or cylindrical, the housing 115 can include a rigid or semi-rigid material such that the housing 115 is rigid or semi-rigid (e.g., not easily deformed or manipulated into another shape or form factor). In examples where the housing 115 includes a pouch form factor, the housing 115 can include a flexible, malleable, or non-rigid material such that the housing 115 can be bent, deformed, manipulated into another form factor or shape.

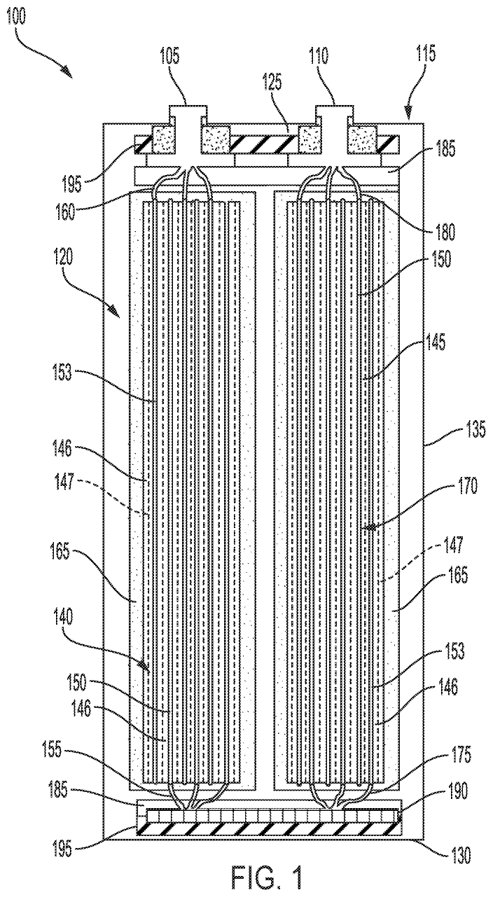

The battery cell 100 can include at least one terminal. For example, the battery cell 100 can include a first terminal 105 and a second terminal 110. The first terminal 105 can have a second polarity and the second terminal 110 can have a first polarity. The first polarity and the second polarity can be opposite. For example, the first terminal 105 can include a positive polarity and the second terminal 110 can include a negative polarity. The terminals 105, 110 can be made from electrically conductive materials to carry electrical current from the battery cell 100 to an electrical load, such as a component or system of an electric vehicle (e.g., the electric vehicle 1205 discussed below). The material of the first terminal 105 can be the same as or different than the second terminal 110. For example, the first terminal 105 can include a copper-based material. The second terminal 110 can include an aluminum-based material. The first terminal 105 can include a second polarity and a second material composition. For example, the first terminal 105 can include a second polarity (e.g., an anodic polarity) and an aluminum-based material composition. The second terminal can include a first polarity and a first material composition. For example, the second terminal can include a first polarity (e.g., a cathodic polarity) and a copper-based material composition. Positive and negative terminals can be same side of the cell (as depicted in FIG. 1, among others) or different sides of the cell (for example, one at cell top, and the other at cell bottom).

The battery cell 100 can include at least one electrode layer stack. For example, the battery cell 100 can include a first electrode layer stack 140 and a second electrode layer stack 170. For example, the first electrode layer stack 140 and the second electrode layer stack 170 can include at least one electrode layer 145, at least one electrode layer 146, at least one separator layer 147, at least one current collector layer 150, and at least one current collector layer 153. The battery cell 100 can include the electrode layer 145 laminated to at least one side of the current collector layer 150. For example, the electrode layer 145 can include a cathode active material or an anode active material, a binder material, and a carbon conductor material combined in a film (e.g., layer, web, sheet) form factor and laminated (e.g., coupled, adhered, bound, sealed) to a side of the current collector layer 150. The battery cell 100 can include the electrode layer 146 laminated to at least one side of the current collector layer 153. For example, the electrode layer 146 can include an anode active material or a cathode active material, a binder material, and a carbon conductor material combined in a film (e.g., layer, web, sheet) form factor and laminated (e.g., coupled, adhered, bound, sealed) to a side of the current collector layer 153. The current collector layer 150 can be a sheet (e.g., foil, layer, web, film) of metallic material, such as an aluminum foil, a copper foil or some other foil. The current collector layer 153 can be a sheet (e.g., foil, layer, web, film) of metallic material, such as a copper foil, an aluminum foil, or some other foil. The separator layer 147 can be a porous polymer material with holes filled electrolyte material to conduct ions from one electrode layer 145 to another electrode layer 146 or vice versa. For example, the separator layer 147 can be or include a liquid electrolyte or a solid electrolyte, as is discussed in detail below.

An electrode layer 145 can be laminated with both a first side and a second side of the current collector layer 150. An electrode layer 146 can be laminated with both a first side and a second side of the current collector layer 153. The separator layer 147 can be positioned between an electrode layer 145 and an adjacent electrode layers 146. For example, the battery cell 100 can include a first electrode layer 145 having a first active material (e.g., an anodic active material) laminated with a first current collector layer 150 and a second electrode layer 146 having a second active material (e.g., an cathodic active material) laminated with a second current collector layer 153 with a separator layer 147 separating the first electrode layer 145 from the second electrode layer 146. The separator layer 147 can facilitate the conduct ions from the first electrode layer 145 to the second electrode layer 146 or from the second electrode layer 146 to the first electrode layer 145.

The battery cell 100 can include the first electrode layer stack 140 and the second electrode layer stack 170 including a plurality of electrode layers 145 and 146 having varying polarity. For example, the electrode layer stack 170 can include at least one electrode layer 145 having a first polarity (e.g., cathodic or anodic) and at least one electrode layer 148 having a second polarity (e.g., anodic or cathodic. Each electrode layer 145 and 146 can be laminated to at least one of a plurality of current collector layers 150 or 153, and with each electrode layer 145 or 146 respectively separated from an adjacent electrode layer 146 or 145 of opposing polarity by at least one separator layer 147. For example, as shown in FIG. 1, among others, the battery cell 100 can include a plurality of electrode layers 145, a plurality of electrode layers 146, a plurality of separator layers 147, and a plurality of current collector layers 150 or 153. An electrode layer stack (e.g., the first electrode layer stack 140 or the second electrode layer stack 170) can include the plurality of electrode layers 145, electrode layers 146, separator layers 147, current collector layers 150, and current collector layers 153 stacked (e.g., positioned adjacent to each other) in a prismatic (e.g., rectangular) form or in a rolled form such that the stack of layers rolled to form a semi-cylindrical shape or a cylindrical shape.

The battery cell 100 can include the current collector layers 150 and 153 having a polarity. For example, the current collector layer 150 can include a first polarity that corresponds with or is related to the electrode layer 145 that is laminated with the current collector layer 150. The current collector layer 153 can include a second polarity that corresponds with or is related to the electrode layer 146 that is laminated with the current collector layer 153. The current collector layers 150 and 153 can have a respective material composition that corresponds with or is related to the electrode layer 145 or 146 that is laminated with the current collector layer 150 or 153. For example, the current collector material 150 can have a first material composition or a first polarity with the current collector layer 150 laminated with a first electrode layer 145 having a first active material (e.g., a cathodic electrode layer). The current collector layer 153 can have a second material composition or a second polarity with the current collector layer 153 laminated with an electrode layer 146 having a second active material (e.g., an anodic electrode layer). The material composition of the current collector layer 150 or 153 can be an aluminum-based material, a copper-based material, or some other material depending upon polarity, for example. For example, the current collector layer 150 can include a copper-based material composition with the current collector layer 150 laminated with an anodic electrode layer (e.g., an electrode layer 145 having an anodic or second polarity) or an aluminum-based material composition with the current collector layer 150 laminated with a cathodic electrode layer (e.g., an electrode layer 145 having a cathodic or first polarity).

The battery cell 100 can include the first electrode layer stack 140 and the second electrode layer stack 170 including an operating voltage. For example, the first electrode layer stack 140 can have an operational voltage of less than 3V, approximately 3V (e.g., 2.8V-3.2V, or greater than 3V (e.g., 3.6V, 3.65V, or some other value). The first electrode layer stack 140 can include an operational voltage between 3.2V and 3.65V. The second electrode layer stack 170 can have an operational voltage of less than 3V, approximately 3V (e.g., 2.8V-3.2V), or greater than 3V (e.g., 3.6V, 3.65V, or some other value). For example the second electrode layer stack 170 can include an operational voltage between 3.2V and 3.65V.

The battery cell 100 can include the first electrode layer stack 140 including a first tab 155 and a second tab 160. For example, the first tab 155 and the second tab 160 can be electrically coupled with at least one of the current collector layers 150 or 153 of the first electrode layer stack 140. For example, the first tab 155 can be electrically coupled with at least one current collector layer 150 and the second tab 160 can be electrically coupled with at least one current collector layer 153. The first tab 155 and the second tab 160 can extend from (e.g., protrude from) the first electrode layer stack 140 as to be accessible from an exterior of the first electrode layer stack 140.

The first tab 155 and the second tab 160 can facilitate the electrical coupling of the first electrode layer stack 140 with another object, device, apparatus, or otherwise. For example, the first tab 155 or the second tab 160 can facilitate the electrical coupling of the first electrode layer stack 140 with a terminal of the battery cell (e.g., the first terminal 105 or the second terminal 110). The first tab 155 or the second tab 160 can facilitate the electrical coupling of the first electrode layer stack 140 to another electrode layer stack (e.g., the second electrode layer stack 170, the third electrode layer stack 700, or some other electrode layer stack).

The battery cell 100 can include first electrode layer stack 140 including the first tab 155 having a first polarity and the second tab 160 having a second polarity. For example, the first tab 155 can include a first polarity (e.g., a cathodic polarity) and the second tab 160 can include a second polarity (e.g., an anodic polarity). The first polarity of the first tab 155 can be different than (e.g., opposite) the second polarity of the second tab 160. The first tab 155 and the second tab 160 can have a material composition corresponding to the respective polarity. For example, the first tab 155 can have a first material composition corresponding to the first polarity. The second tab 160 can have a second material composition correspond to the second polarity. The first tab 155 can include an aluminum-based material composition, for example. The second tab 160 can include a copper-based material composition, for example.

The first tab 155 or the second tab 160 can be integrated with or coupled with a current collector layer 150 or 153 of the first electrode layer stack 140. For example, the first tab 155 can be an extension of (e.g., a part of, integrated with) the current collector layer 150. The second tab 160 can be an extension of (e.g., a part of, integrated with) the current collector layer 153. The first tab 155 or the second tab 160 can be a portion of the current collector layers 150 or 153 that extends from the first electrode layer stack 140. For example, the current collector layers 150 and 153 can respectively extend beyond the electrode layers 145 and 146 that is laminated to the current collector layer 150 or 153 such that first tab 155 or the second tab 160 extends beyond the first electrode layer stack 140 as a portion of the current collector layer 150 or 153. The first tab 155 or the second tab 160 can be separate from—but coupled to—the current collector layer 150, 153. For example, the first tab 155 or the second tab 160 can be welded to, adhered to, or otherwise coupled to the current collector layer 150, 153. The first tab 155 can include a material composition similar to the current collector layer 150 to which it is coupled or with which it is integrated. For example, the first tab 155 can include an aluminum-based material composition with the current collector layer 150 laminated with a cathodic electrode layer (e.g., an electrode layer 145 having a cathodic or first polarity). The second tab 160 can include a material composition similar to the current collector layer 153 to which it is coupled or with which it is integrated. For example, the second tab 160 can include a copper-based material composition with the current collector layer 150 laminated with an anodic electrode layer (e.g., an electrode layer 146 having an anodic or second polarity).

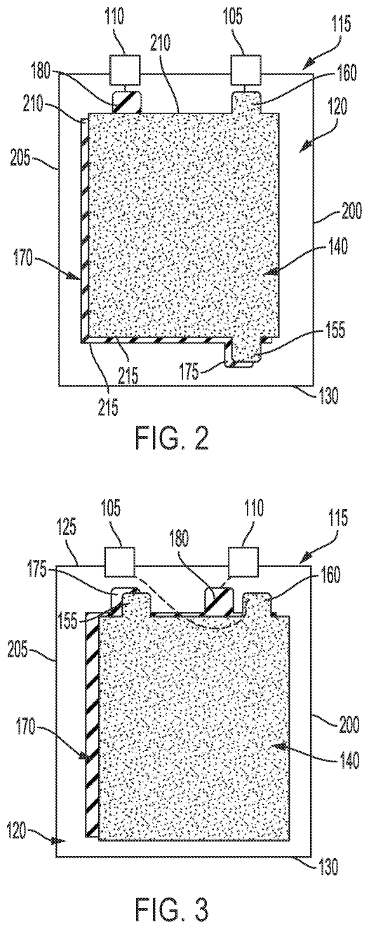

The battery cell 100 can include the first tab 155 of the first electrode layer stack 140 in a first orientation. The first orientation can include the first tab 155 of the first electrode layer stack 140 positioned proximate (e.g., near to, by, adjacent, within ten millimeters, within three centimeters, or within some other distance) to the second wall 130 of the housing 115. For example, the battery cell 100 can include the first tab 155 positioned proximate the second wall 130 with the first electrode layer stack 140 positioned within the cavity 120 of the housing 115, as depicted in FIG. 2, among others. The battery cell 100 can include the second tab 160 of the first electrode layer stack 140 in a second orientation. The second orientation can include the second tab 160 positioned proximate (e.g., near to, by, adjacent, within ten millimeters, within three centimeters, or within some other distance) the first wall 125 of the housing 115. For example, the battery cell 100 can include the second tab 160 positioned proximate the first wall 125 with the first electrode layer stack 140 positioned within the cavity 120 of the housing 115, as depicted in FIG. 2, among others. For example, the first electrode layer stack 140 can include the first tab 155 protruding (e.g., extending from) a current collector layer 150 of the first electrode layer stack 140 in a first direction, and the second tab 160 protruding from a current collector layer 153 in a second direction. The first direction can be opposite the second direction. The first tab 155 can extend in the first direction towards the second wall 130 with the first electrode layer stack 140 positioned within the cavity 120 of the housing 115. The second tab 160 can extend in the second direction towards the first wall 125 with the first electrode layer stack 140 within the cavity 120 of the housing 115. The first tab 155 and the second tab 160 can extend in opposite directions with the first electrode layer stack 140 within the cavity 120 of the housing 115. The first tab 155 or the second tab 160 can extend from the first electrode layer stack 140 in a direction perpendicular to the first wall 125 or the second wall 130, a direction at an angle with respect to the first wall 125, the second wall 130, or the sidewall 135, or in some other direction.

The battery cell 100 can include the first tab 155 of the first electrode layer stack 140 in a first orientation. The first orientation can include the first tab 155 positioned proximate (e.g., near to, by, adjacent, within ten millimeters, within three centimeters, or within some other distance) a second side 205 of the housing 115. For example, the first tab 155 can be positioned closer to the second side 205 of the housing 115 than to the first side 200 with the first electrode layer stack 140 positioned within the cavity 120 of the housing 115, as depicted in FIG. 3, among others. The battery cell 100 can include the second tab 160 of the first electrode layer stack 140 in a second orientation. The second orientation can include the second tab 160 positioned proximate (e.g., near to, by, adjacent, within ten millimeters, within three centimeters, or within some other distance) a first side 200 of the housing 115. For example, the second tab 160 can be positioned closer to the first side 200 of the housing 115 than to the second side 205 with the first electrode layer stack 140 positioned within the cavity 120 of the housing 115, as depicted in FIG. 3, among others. The first terminal 105 can be positioned closer to the first side 200 of the housing 115 than to the second side 205. The first terminal 105 can be positioned closer to the second side 205 of the housing 115 than to the second side 205. The second terminal 110 can be positioned closer to the second side 205 of the housing 115 than to the first side 200. The second terminal 110 can be positioned closer to the first side 200 of the housing 115 than to the second side 205.

The battery cell 100 can include the first electrode layer stack 140 having the first tab 155 and the second tab 160 in various orientations. For example, the first tab 155 can be positioned proximate to (e.g., near to, by, adjacent, within ten millimeters, within three centimeters, or within some other distance) one or more of the first wall 125, the second wall 130, the sidewall 135, the first side 200, or the second side 205. For example, the first tab 155 can be positioned proximate the second wall 130 and proximate the first side 200, as shown in FIG. 2, among others. The first tab 155 can be positioned proximate the first wall 125 and the second side 205, as depicted in FIG. 3, among others. The second tab 160 can be positioned proximate to (e.g., near to, by, adjacent, within ten millimeters, within three centimeters, or within some other distance) one or more of the first wall 125, the second wall 130, the sidewall 135, the first side 200, or the second side 205. For example, the second tab 160 can be positioned proximate the first wall 125 and the first side 200, as depicted in FIGS. 2 and 3, among others.

The battery cell 100 can include the second electrode layer stack 170 including a first tab 175 and a second tab 180. For example, the first tab 175 and the second tab 180 can be electrically coupled with at least one of the current collector layers 153 or the current collector layers 150, respectively of the second electrode layer stack 170. The first tab 175 and the second tab 180 can extend from (e.g., protrude from) the second electrode layer stack 170 as to be accessible from an exterior of the second electrode layer stack 170. The first tab 175 and the second tab 180 can facilitate the electrical coupling of the first electrode layer stack 140 with another object, device, apparatus, or otherwise. For example, the first tab 175 or the second tab 180 can facilitate the electrical coupling of the second electrode layer stack 170 with a terminal of the battery cell (e.g., the first terminal 105 or the second terminal 110). The first tab 175 or the second tab 180 can facilitate the electrical coupling of the second electrode layer stack 170 to another electrode layer stack (e.g., the first electrode layer stack 140, the third electrode layer stack 700, or some other electrode layer stack).

The battery cell 100 can include the second electrode layer stack 170 including the first tab 175 including the second polarity and the second tab 180 including the first polarity. The battery cell 100 can include second electrode layer stack 170 including the first tab 175 having a second polarity and the second tab 180 having a first polarity. For example, the first tab 175 can include a second polarity (e.g., an anodic polarity) and the second tab 180 can include a first polarity (e.g., a cathodic polarity). The second polarity of the first tab 175 can be different than (e.g., opposite) the first polarity of the second tab 180 and opposite the first polarity of the first tab 155 of the first electrode layer stack 140. The first polarity of the second tab 180 can be opposite the second polarity of the first tab 175 and opposite the second polarity of the second tab 160 of the first electrode layer stack 140. The first tab 175 and the second tab 180 can have a material composition corresponding to the respective polarity. For example, the first tab 175 can have a second material composition corresponding to the second polarity. The second tab 180 can have a first material composition correspond to the first polarity. The first tab 175 can include a copper-based material composition. The second tab 180 can include an aluminum-based material composition.

The first tab 175 or the second tab 180 can be integrated with or coupled with a current collector layer 150 or a current collector layer 153 of the second electrode layer stack 170. For example, the first tab 175 or the second tab 180 can be an extension of (e.g., a part of, integrated with) the current collector layer 150 or the current collector layer 153. The first tab 175 or the second tab 180 can be a portion of the current collector layer 150, 153 that extends from the second electrode layer stack 170. For example, the current collector layer 150 can extend beyond the electrode layer 145 that is laminated to the current collector layer 150 such that first tab 175 extends beyond the second electrode layer stack 170 as a portion of the current collector layer 150. The current collector layer 153 can extend beyond the electrode layer 146 that is laminated to the current collector layer 153 such that the second tab 180 extends beyond the second electrode layer stack 170 as a portion of the current collector layer 153. The first tab 175 or the second tab 180 can be separate from—but coupled to—the current collector layer 150 or 153. For example, the first tab 175 or the second tab 180 can be welded to, adhered to, or otherwise coupled to the current collector layer 150 or 153, respectively. The first tab 175 can include a material composition similar to the current collector layer 150 to which it is coupled or with which it is integrated. For example, the first tab 175 can include an aluminum-based material composition with the current collector layer 150 laminated with a cathodic electrode layer (e.g., an electrode layer 145 having a cathodic or first polarity). The second tab 180 can include a material composition similar to the current collector layer 153 to which it is coupled or with which it is integrated. For example, the second tab 180 can include a copper-based material composition with the current collector layer 150 laminated with an anodic electrode layer (e.g., an electrode layer 146 having an anodic or second polarity).

The battery cell 100 can include the first tab 175 of the second electrode layer stack 170 in a first orientation. The first orientation can include the first tab 175 of the second electrode layer stack 170 positioned proximate (e.g., near to, by, adjacent, within ten millimeters, within three centimeters, or within some other distance) to the second wall 130 of the housing 115. For example, the battery cell 100 can include the first tab 175 positioned proximate the second wall 130 with the second electrode layer stack 170 positioned within the cavity 120 of the housing 115, as depicted in FIG. 2, among others. The battery cell 100 can include the second tab 180 of the second electrode layer stack 170 in a second orientation. The second orientation can include the second tab 180 positioned proximate (e.g., near to, by, adjacent, within ten millimeters, within three centimeters, or within some other distance) the first wall 125 of the housing 115. For example, the battery cell 100 can include the second tab 160 positioned proximate the first wall 125 with the second electrode layer stack 170 positioned within the cavity 120 of the housing 115, as depicted in FIG. 2, among others. For example, the second electrode layer stack 170 can include the first tab 175 protruding (e.g., extending from) a current collector layer 150 of the second electrode layer stack 170 in a first direction, and the second tab 180 protruding from a current collector layer 153 in a second direction. The first direction can be opposite the second direction. The first tab 175 can extend in the first direction towards the second wall 130 with the second electrode layer stack 170 positioned within the cavity 120 of the housing 115. The second tab 180 can extend in the second direction towards the first wall 125 with the second electrode layer stack 170 positioned within the cavity 120 of the housing 115. The first tab 175 and the second tab 180 can extend in opposite directions with the second electrode layer stack 170 positioned within the cavity 120 of the housing 115. The first tab 175 or the second tab 180 can extend from the second electrode layer stack 170 in a direction perpendicular to the first wall 125 or the second wall 130, a direction at an angle with respect to the first wall 125, the second wall 130, or the sidewall 135, or in some other direction.

The battery cell 100 can include the first tab 175 of the second electrode layer stack 170 in a first orientation. The first orientation can include the first tab 175 positioned proximate (e.g., near to, by, adjacent, within ten millimeters, within three centimeters, or within some other distance) a second side 205 of the housing 115. For example, the first tab 175 can be positioned closed to the second side 205 of the housing 115 than to the first side 200 with the first electrode layer stack 140 positioned within the cavity 120 of the housing 115, as depicted in FIG. 3, among others. The battery cell 100 can include the second tab 180 of the second electrode layer stack 170 in a second orientation. The second orientation can include the second tab 180 positioned proximate (e.g., near to, by, adjacent, within ten millimeters, within three centimeters, or within some other distance) a second side 205 of the housing 115. For example, the second tab 180 can be positioned closer to the second side 205 of the housing 115 than to the first side 200 with the second electrode layer stack 170 positioned within the cavity 120 of the housing 115, as depicted in FIG. 3, among others.

The battery cell 100 can include the second electrode layer stack 170 having the first tab 175 and the second tab 180 in various orientations. For example, the first tab 175 can be positioned proximate to (e.g., near to, by, adjacent, within ten millimeters, within three centimeters, or within some other distance) one or more of the first wall 125, the second wall 130, the sidewall 135, the first side 200, or the second side 205. For example, the first tab 175 can be positioned proximate the second wall 130 and proximate the first side 200, as shown in FIG. 2, among others. The first tab 175 can be positioned proximate the first wall 125 and the second side 205, as depicted in FIG. 3, among others. The second tab 180 can be positioned proximate to (e.g., near to, by, adjacent, within ten millimeters, within three centimeters, or within some other distance) one or more of the first wall 125, the second wall 130, the sidewall 135, the first side 200, or the second side 205. For example, the second tab 180 can be positioned proximate the first wall 125 and the second side 205, as depicted in FIG. 2, among others. The second tab 180 can be positioned proximate the first wall 125 and the first side 200 or proximate the first wall 125 and approximately (e.g., ±25%) equidistant between the first side 200 and the second side 205, as depicted in FIG. 3, among others.

The battery cell 100 can include a first electrode layer 140 stack positioned within the housing 115. For example, the battery cell 100 can include the first electrode layer stack 140 positioned within the cavity 120 of the housing 115. The battery cell 100 can include the first electrode layer stack 140 positioned within between the first wall 125 and the second wall 130 of the housing 115. The first electrode layer stack 140 can be enclosed by the housing 115 such that the first electrode layer stack 140 is closed-off from an exterior environment. The cavity 120 can include a volume that is sufficient to house the first electrode layer stack 140 and additional electrode layer stacks (e.g., the second electrode layer stack 170).

The battery cell 100 can include the second electrode layer stack 170 positioned within the housing 115. For example, the battery cell 100 can include the second electrode layer stack 170 positioned within the cavity 120 of the housing 115. The battery cell 100 can include the second electrode layer stack 170 positioned within between the first wall 125 and the second wall 130 of the housing 115. The second electrode layer stack 170 can be enclosed by the housing 115 such that the second electrode layer stack 170 is closed-off from an exterior environment. The cavity 120 can include a volume that is sufficient to house the second electrode layer stack 170 and additional electrode layer stacks (e.g., the first electrode layer stack 140).

The battery cell 100 can include the second electrode layer stack 170 positioned within the cavity 120 of the housing 115 with the first electrode layer stack 140 also positioned within the cavity 120 of the housing 115. The battery cell 100 can include multiple electrode layer stacks positioned within the cavity 120 of the housing 115. For example, the battery cell 100 can include both the second electrode layer stack 170 and the first electrode layer stack 140 simultaneously positioned within the cavity 120 of the housing 115. The battery cell 100 can include the first electrode layer stack 140, the second electrode layer stack 170, or other electrode layer stacks. For example, the battery cell can include two or more electrode layer stacks (e.g., three, four, ten, or some other number of electrode layer stacks) within the cavity 120 of the housing 115. The cavity 120 can include a volume that is sufficient to house both the first electrode layer stack 140 and the second electrode layer stack 170 together. The cavity 120 can include a volume that is sufficient to house the first electrode layer stack 140, the second electrode layer stack 170, and additional electrode layer stacks (e.g., the third electrode layer stack 700).

The battery cell 100 can include the first electrode layer stack 140 and the second electrode layer stack 170 in various orientations with respect to each other. For example, the first electrode layer stack 140 can be positioned proximate (e.g., near to, by, adjacent, within ten millimeters, within three centimeters, or within some other distance) the first side 200 of the housing 115. The battery cell 100 can include the second electrode layer stack 170 positioned proximate (e.g., near to, by, adjacent, within ten millimeters, within three centimeters, or within some other distance) the second side 205 of the housing 115. The first electrode layer stack 140 can be positioned between the second electrode layer stack 170 and one or more of the first wall 125, the second wall, a sidewall 135, the first side 200, or the second side 205. The second electrode layer stack 170 can be positioned between the first electrode layer stack 140 and at least one of the first wall 125, the second wall 130, a sidewall 135, the first side 200, or the second side 205. For example, the first electrode layer stack 140 can be positioned next to (e.g., adjacent to), on top of, or below the second electrode layer stack 170 within the cavity 120 of the housing 115.

The battery cell 100 can include the first tab 155 of the first electrode layer stack 140 coupled with the first tab 175 of the second electrode layer stack 170. For example the first tab 155 of the first electrode layer stack 140 can be electrically coupled with the first tab 175 of the second electrode layer stack 170. Electricity can be conducted between the first electrode layer stack 140 and the second electrode layer stack 170 with the first tab 155 of the first electrode layer stack 140 electrically coupled with the first tab 175 of the second electrode layer stack 170. The first tab 155 of the first electrode layer stack 140 can contact the first tab 175 of the second electrode layer stack 170 such that electricity can be conducted from the first tab 155 to the first tab 175 or from the first tab 175 to the first tab 155. For example, the first tab 155 of the first electrode layer stack 140 can be joined with the first tab 175 of the second electrode layer stack 170 via one or more joining methods. The first tab 155 of the first electrode layer stack 140 can be welded to, friction welded to, clamped to, adhered to, or otherwise joined with the first tab 175 of the second electrode layer stack 170. The first tab 155 of the first electrode layer stack 140 can be coupled with a first connector (e.g., the connector 190 as discussed below) or a portion of a connector, and the first tab 175 of the second electrode layer stack 170 can be coupled with a second connector (e.g., the connector 190) or a portion of a connector. The first tab 155 of the first electrode layer stack 140 can be electrically coupled with the first tab 175 of the second electrode layer stack 170 by coupling a first connector (e.g., a first portion 400 of the connector 190) to a second connector (e.g., the second portion 405 of the connector 190), as is discussed in further detail below.

The first tab 155 of the first electrode layer stack 140 electrically coupled with the first tab 175 of the second electrode layer stack 170 with the first tab 155 having a polarity that differs from the first tab 175. For example, the first tab 155 of the first electrode layer stack 140 can include a first polarity (e.g., a cathodic polarity) and the first tab 175 of the second electrode layer stack 170 can include a second polarity (e.g., an anodic polarity). The first electrode layer stack 140 and the second electrode layer stack 170 can be electrically coupled in a series configuration with the first tab 155 of the first electrode layer stack 140 electrically coupled with the first tab 175 of the second electrode layer stack 170 where the first tab 155 of the first electrode layer stack 140 includes a first polarity and the first tab 175 of the second electrode layer stack 170 includes a second polarity.

The battery cell 100 can include an operating voltage that is greater than an operating voltage of the first electrode layer stack 140 or the second electrode layer stack 170. For example, the battery cell 100 can include the first electrode layer stack 140 and the second electrode layer stack 170 electrically coupled in a series configuration. The operating voltage of the battery cell 100 can be approximately equal to (e.g., ±95%) the sum of the operating voltage of the first electrode layer stack (e.g., 3.2V-3.65V) and the operating voltage of the second electrode layer stack 170 (e.g., 3.2V-3.65V). For example, the operating voltage of the battery cell can be 6.4V-7.2V with the first electrode layer stack 140 and the second electrode layer stack 170 electrically coupled in a series configuration. The operating voltage of the battery cell 100 can be greater than the operating voltage of the first electrode layer stack 140 or the second electrode layer stack 170 to support various operations or systems. For example, the operating voltage of the battery cell 100 can be greater than the operating voltage of the first electrode layer stack 140 or the second electrode layer stack 170 to support a DC fast-charging application of an electric vehicle or a similar operation.

The battery cell 100 can include the second tab 160 of the first electrode layer stack 140 coupled with the first terminal 105. For example, the second tab 160 of the first electrode layer stack 140 can be electrically coupled with the first terminal 105 of the battery cell 100. Electricity can be conducted between the first terminal 105 and the first electrode layer stack 140 with the first terminal 105 electrically coupled with the second tab 160. For example, a device or system can be coupled with the first terminal 105. The first terminal 105 can be coupled with a system of an electric vehicle, such as an electric motor, a charging system, a computing system, or some other system or device. The second tab 160 can include a polarity. The first terminal 105 can include a polarity. For example, the polarity of the second tab 160 can be the same as the polarity of the first terminal 105. The polarity of the second tab 160 can be different than (e.g., opposite) the polarity of the first terminal 105.

The battery cell 100 can include the second tab 180 of the second electrode layer stack 170 coupled with the second terminal 110. For example, the second tab 180 of the second electrode layer stack 170 can be electrically coupled with the second terminal 110 of the battery cell 100. Electricity can be conducted between the second terminal 110 and the second electrode layer stack 170 with the second terminal 110 electrically coupled with the second tab 180. For example, a device or system can be coupled with the second terminal 110. The second terminal 110 can be coupled with a system of an electric vehicle, such as an electric motor, a charging system, a computing system, or some other system or device. The second tab 180 can include a polarity. The second terminal 110 can include a polarity. For example, the polarity of the second tab 180 can be the same as the polarity of the second terminal 110. The polarity of the second tab 180 can be different than (e.g., opposite) the polarity of the second terminal 110.

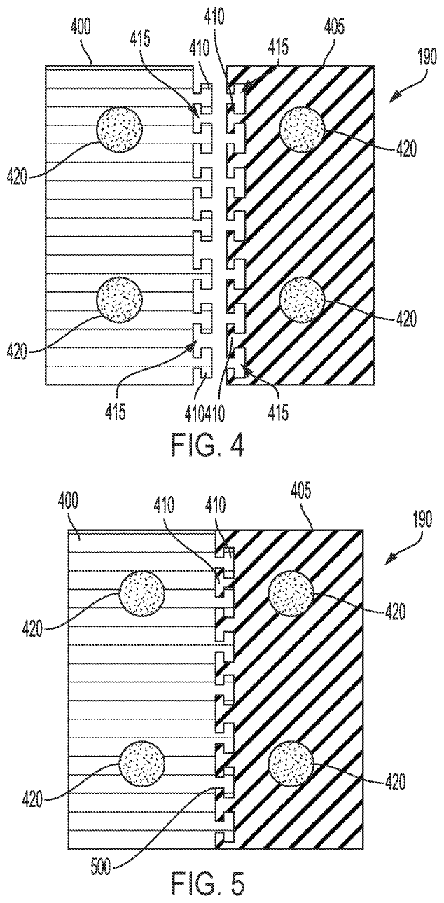

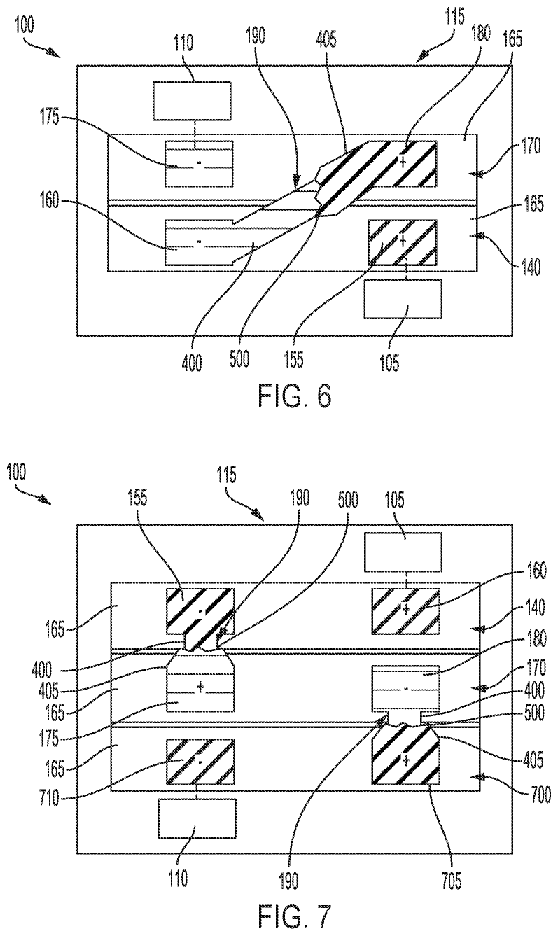

The battery cell 100 can include the first tab 155 of the first electrode layer stack 140 coupled with the first tab 175 of the second electrode layer stack 170 via a connector 190. For example, as shown in FIGS. 4-5, among others, the connector 190 can include a first portion 400 and a second portion 405. The connector 190 can include the first portion 400 electrically coupled with the second portion 405. For example, the first portion 400 can be mechanically joined with the second portion 405 such that the first portion 400 contacts the second portion 405 along the joint 500. The first portion 400 can be coupled with the first electrode layer stack 140, and the second portion can be coupled with the second electrode layer stack 170. The first electrode layer stack 140 can be electrically coupled to the second electrode layer stack 170 with the first portion 400 of the connector 190 coupled with the second portion 405. For example, the connector 190 can conduct electricity from the first electrode layer stack 140 to the second electrode layer stack 170. The first portion 400 can be coupled with the second portion 405 at a joint 500 via various coupling methods. For example, the first portion 400 can be coupled with the second portion 405 via welding, friction welding, an electrically conductive adhesive, fasteners, the interlocking of mechanical components, or some other joining method.

As depicted in FIGS. 4 and 5, among others, the battery cell 100 can include the connector 190 including at least one tooth 410 and at least one groove 415. For example, the first portion 400 can include a plurality of teeth 410 that protrude outwardly from the first portion 400. The teeth 410 can be T-shaped, curved, jig-saw shaped, or otherwise shaped. The extension of the teeth 410 from the first portion 400 can create corresponding grooves 415 of the first portion 400. For example, a groove 415 can be created between adjacent teeth 410. The second portion 405 can include a plurality of teeth 410 that protrude outwardly from the second portion 405. The teeth 410 can be T-shaped, curved, jig-saw shaped, or otherwise shaped. The extension of the teeth 410 from the second portion 405 can create corresponding grooves 415 of the second portion 405. For example, a groove 415 can be created between adjacent teeth 410. Each groove 415 of the second portion 405 can correspond to at least one tooth 410 of the first portion 400. Each groove 415 of the first portion 400 can correspond to at least one tooth 410 of the second portion 405.

The battery cell 100 can include a groove 415 of the second portion 405 to receive a tooth 410 of the first portion 400. For example, a plurality of teeth 410 of the first portion 400 can be received by a plurality of grooves of the second portion 405 and a plurality of teeth 410 of the second portion 405 can be received by a plurality of grooves 415 of the first portion 400 such that the first portion 400 is mechanically coupled with the second portion 405. The teeth 410 of the first portion 400 can fit snugly (e.g., tightly, with some amount of mechanical resistance) within the grooves 415 of the second portion 405 such that the first portion 400 and the second portion 405 can only be separated with sufficient force (e.g., 10 lbs of separating force, 1 kg of separating force, or some other force). The teeth 410 of the second portion 405 can fit snugly (e.g., tightly, with some amount of mechanical resistance) within the grooves 415 of the first portion 400 such that the first portion 400 and the second portion 405 can only be separated with sufficient force (e.g., 10 lbs of separating force, 1 kg of separating force, or some other force).

The battery cell 100 can include the first portion 400 electrically coupled with the second portion 405 to electrically couple the first electrode layer stack 140 with the second electrode layer stack 170. For example, the first portion 400 of the connector 190 can be mechanically coupled with the second portion 405 of the connector 190 such that electricity can be conducted or flow from the first portion 400 of the connector 190 to the second portion of the connector 190. The first portion 400 of the connector 190 can be electrically coupled with the second portion 405 of the connector 190 such that electricity can flow or be conducted from the first portion 400 (and by extension the first tab 155 of the first electrode layer stack 140) to the second portion 405 (and by extension to the first tab 175 of the second electrode layer stack 170) or from the second portion 405 to the first portion 400. Accordingly, the first electrode layer stack 140 can be electrically coupled to the second electrode layer stack 170 via the connector 190.

The battery cell 100 can include the connector 190 to electrically couple the first electrode layer stack 140 with the second electrode layer stack 170 in a series configuration. For example, the first tab 155 of the first electrode layer stack 140 can include a first polarity (e.g., a negative polarity, an anodic polarity) and the first tab 175 of the second electrode layer stack 170 can include a second polarity (e.g., a positive polarity, a cathodic polarity). The first tab 155 of the first electrode layer stack 140 can have a polarity that differs from (e.g., is opposite) the polarity of the first tab 175 of the second electrode layer stack 170. The first electrode layer stack 140 and the second electrode layer stack 170 can be electrically coupled in series such that an operational voltage of the battery cell 100 can be the sum of the operational voltage of the first electrode layer stack 140 and the second electrode layer stack 170. For example, and as indicated above, the first electrode layer stack 140 can have an operational voltage of 3.2V to 3.65V in some examples. The second electrode layer stack 170 can have an operational voltage of 3.2V to 3.65V. The battery cell 100 can include an operational voltage of 6.4V to 7.3V with the first electrode layer stack 140 and the second electrode layer stack 170 electrically coupled in a series configuration. For example, coupling the first electrode layer stack 140 with the second electrode layer stack in a series configuration can increase the operational voltage of the battery cell 100.

The battery cell 100 can include the first portion 400 and the second portion 405 of the connector 190 including a first form factor and a second form factor, respectively. For example, the battery cell 100 can include the first portion 400 including a first form factor and the second portion 405 including a second form factor. The first form factor can include a first cross-sectional shape, a first cross-sectional dimension (e.g., length, width, thickness), or another feature. The second form factor can include a second cross-sectional shape, a second cross-sectional dimension (e.g., length, width, thickness). The first form factor and the second form factor can be the same such that the first cross-sectional shape is the same as or substantially similar to (e.g., ±95% similar to) the second cross-sectional shape, the first cross-sectional dimension is the same as or substantially similar to (e.g., ±95% similar to) the second cross-sectional dimension, or another feature of the first portion 400 is the same as or substantially similar to (e.g., ±95% similar to) another feature of the second portion 405. The first form factor can be different than the second form factor. For example, the first cross-sectional dimension can be less than the second cross-sectional dimension such the first portion 400 is smaller than the second portion 405 in at least one dimension (e.g., length, width, thickness, or some other dimension). The first form factor can correspond to a material composition or polarity of the first portion 400 and the second form factor can correspond to a material composition or polarity of the second portion 405. For example, the first portion 400 can be associated with the first tab 155 of the first electrode layer stack 140 with the first tab 155 having a first polarity (e.g., a polarity associated with an electrode layer 145). The second portion 405 can be associated with the first tab 175 of the second electrode layer stack 170 with the first tab 175 having a second polarity (e.g., a polarity associated with a cathode electrode layer 170).

The battery cell 100 can include the first portion 400 of the connector 190 and the second portion 405 of the connector 190 including the same or a substantially similar (e.g., ±95% similar) conductivity. For example, the first portion 400 can have a first material composition and a first form factor (e.g., cross-sectional shape, cross-sectional area), which can cause the first portion 400 to have a first electrical conductivity. The second portion 405 can have a second material composition and a second form factor (e.g., cross-sectional shape, cross-sectional area), which can cause the second portion 405 to have a second electrical conductivity. The first electrical conductivity can be the same as or substantially similar to (e.g., ±98% similar to) the second electrical conductivity.

The battery cell 100 can include the connector 190 including at least one coupling spot 420. For example, the coupling spot can be a particular portion or region of the connector 190 within which a tab of an electrode layer stack can be coupled. For example, the first portion 400 of the connector 190 can include at least one coupling spot 420. The first tab 155 of the first electrode layer stack 140 can be coupled with the first portion 400 of the connector 190 at the coupling spot 420. For example, the first tab 155 can be joined with the connector 190 at the coupling spot 420 via welding, friction welding, an electrically conductive adhesive, or some other joining method. The second portion 405 of the connector 190 can include at least one coupling spot 420. The first tab 175 of the second electrode layer stack 170 can be coupled with the second portion 405 of the connector 190 at the coupling spot 420. For example, the first tab 175 can be joined with the connector 190 at the coupling spot 420 via welding, friction welding, an electrically conductive adhesive, or some other joining method.

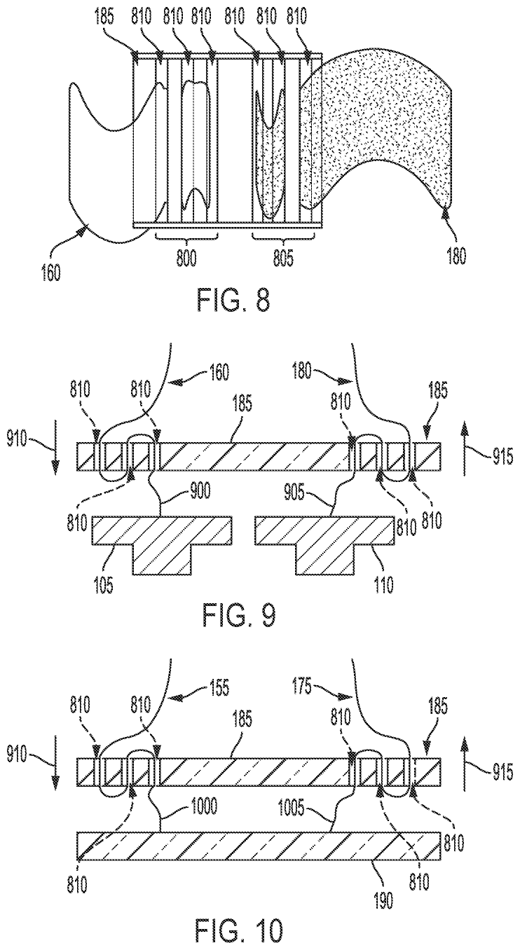

As depicted in FIGS. 7 and 8, among others, the battery cell 100 can include a busbar connector. For example, the battery cell 100 can include the connector 190, where the connector 190 can be or include a busbar-style connector. The connector 190 can be a bimetallic connector 190 including the first portion 400 and the second portion 405. The first portion 400 and the second portion 405 can be metallic members coupled with the first tab 155 of the first electrode layer 140 or the first tab 175 of the second electrode layer 170, respectively. For example, the first portion 400 can include a first material composition (e.g., a copper-based material composition) with the first portion 400 coupled with the first tab 155 of the first electrode layer stack 140 where the first tab 155 of the electrode layer stack 140 includes a first polarity (e.g., a polarity associated with at least one electrode layer 145). The second portion 405 of the busbar connector 190 can include a second material composition (e.g., an aluminum-based material composition) with the second portion 405 coupled with the first tab 175 of the second electrode layer stack 170. The first portion 400 or the second portion 405 can be slender (e.g., elongated, extended, thin) members. For example, the busbar connector 190 can include the first portion 400 including a bar- or strip-like form factor. The busbar connector 190 can include the second portion 405 including a bar- or strip-like form factor. The first portion 400 or the second portion 405 that include a first form factor and a second form factor, respectively, such that the first portion 400 can have a different cross-sectional shape, cross-sectional dimension, or another feature that differs from the second portion 405. The first form factor and the second form factor can be the same or substantially similar (e.g., ±95% similar).

The battery cell 100 can include the busbar connector 190 with the first portion 400 coupled with the second portion 405. For example, the first portion 400 can be a slender member coupled with the second portion 405, where the second portion is also a slender member. As indicated above, the first portion 400 and the second portion 405 can include differing or similar form factors. The first portion 400 can be welded to the second portion at a joint 425. The joint 425 can be a point, surface, or portion of the connector 190 where the first portion 400 meets (e.g., is joined with, is coupled with) the second portion 405. The joint 425 can be a welded joint, a mechanical joint, or some other type of joint. For example, the joint 425 can be a mechanical joint formed by an interaction between at least one tooth (e.g., a protrusion similar to the tooth 410) of the first portion 400 and a groove (e.g., a crevice, notch, indentation, cleft, or nock similar to the groove 415) of the second portion 405. The first portion 400 can be friction welded to the second portion 405 at the joint 425 or joined in some other way. The first portion 400 of the busbar connector 190 can be electrically coupled with the second portion 405 of the busbar connector 190 such that electricity can be pass or be conducted from the first portion 400 (and by extension the first tab 155 of the first electrode layer stack 140) to the second portion 405 (and by extension to the first tab 175 of the second electrode layer stack 170) or from the second portion 405 to the first portion 400. Accordingly, the first electrode layer stack 140 can be electrically coupled to the second electrode layer stack 170 via the busbar connector 190.

As depicted in FIG. 1, among others, the battery cell 100 can include at least one insulative pouch. For example, the battery cell 100 can include a first insulative pouch 165 (e.g., a bag) surrounding the first electrode layer stack 140. The battery cell 100 can include the first insulative pouch 165 to electrically insulate the first electrode layer stack 140 from the housing 115, the second electrode layer stack 170, some other electrode layer stack, or some other object within the cavity 120. The battery cell 100 can include a second insulative pouch 165 surrounding the second electrode layer stack 170. For example, the battery cell 100 can include the second insulative pouch 165 to electrically insulate the second electrode layer stack 170 from the housing 115, the first electrode layer stack 140, some other electrode layer stack (e.g., the third electrode layer stack 700 as discussed in detail below) or some other object within the cavity 120.

The first insulative pouch 165, the second insulative pouch 165, and any other insulative pouch 165 can be or include an electrically insulative material, such as Polypropylene, Polyethylene terephthalate, Polyimide, or polymer materials with comparable electrical insulation property and thermal, chemical, or mechanical stability to those listed materials. The electrically insulative material of the insulative pouch 165 can reduce, prevent, or substantially prevent (e.g., prevent ±98%) the conduction or flow of electricity between the first electrode layer stack 140, the second electrode layer stack 170, or another electrode layer stack and the housing 115, another component within the cavity 120 of the housing 115, or another electrode layer stack. For example, the battery cell 100 can include the first electrode layer stack 140 electrically coupled with the second electrode layer stack 170 only via the first tab 155 of the first electrode layer stack 140, the connector 190, and the first tab 175 of the second electrode layer stack 170. The first electrode layer stack 140 can be electrically coupled with the second electrode layer stack 170 via the first tab 155, the connector 190, and the first tab 175 but with the electrode layers 145, electrode layers 146, separator layer 147, current collector layers 150, and current collector layers 153 of each electrode layer stack electrically insulated from the other. For example, the only electrical connection between the first electrode layer stack 140 and any other component or electrode layer stack (e.g., the second electrode layer stack 170) can be made via the first tab 155 and the second tab 160. The only electrical connection between the second electrode layer stack 170 and any other component or electrode layer stack (e.g., the first electrode layer stack 140) can be made via the first tab 175 and the second tab 180.

As depicted in FIGS. 1 and 8-10, among others, the battery cell 100 can include at least one insulative member. For example, the battery cell 100 can include at least one inner insulative member 185 or at least one outer insulative member 195. The inner insulative member 185 can electrically insulate the first electrode layer stack 140 or the second electrode layer stack 170 from the connector 190. For example, the inner insulative member 185 can be a sheet or layer of electrically insulative material, such as Polypropylene, Polyethylene terephthalate, Polyimide, or polymer materials with comparable electrical insulation property and thermal, chemical, or mechanical stability to those listed materials. The inner insulative member 185 can have a prismatic form factor (e.g., a height, width, and thickness), a cylindrical form factor (e.g., a thickness and a radius or diameter), or some other form factor. For example, if the housing 115 includes a prismatic form factor, the inner insulative member 185 can include a prismatic form factor having a cross-sectional shape similar to a cross-sectional shape of the housing 115 such that the inner insulative member 185 fits within the cavity 120 of the housing and is proximate to (e.g., within one centimeter of, within three centimeters of, or within some other distance of) the sides 135 of the housing 115. If the housing 115 includes a cylindrical form factor, the inner insulative member 185 can include a form factor having a cylindrical form factor having a cylindrical cross-sectional shape similar to a cylindrical cross-sectional shape of the housing 115 such that the inner insulative member 185 fits within the cavity 120 of the housing 115 and is proximate to (e.g., within one centimeter of, within three centimeters of, within some other distance of) the sides 135 of the housing 115.

The inner insulative member 185 can electrically insulate the first electrode layer stack 140 from the connector 190. The inner insulative member 185 can electrically insulate the second electrode layer stack 170 from the connector 190. For example, the inner insulative member 185 can prevent an electrical connection, electrical interference, or some other electrical phenomenon from occurring between the first electrode layer stack 140 and the connector 190 or between the first electrode layer stack 140 and the housing 115 other than the electrical connection established between the first electrode layer stack 140 and the connector 190 via the first tab 155 of the first electrode layer stack 140. The inner insulative member 185 can prevent an electrical connection, electrical interference, or some other electrical phenomenon from occurring between the second electrode layer stack 170 and the connector 190 or between the second electrode layer stack 170 and the housing 115 other than the electrical connection established between the second electrode layer stack 170 and the connector 190 via the first tab 175 of the second electrode layer stack 170.

The battery cell 100 can include the inner insulative member 185 to relieve a tension on a tab of an electrode layer stack. For example, the inner insulative member 185 can reduce, substantially prevent (e.g., prevent ±80%), or restrict a tensile force applied to a tab of an electrode layer stack that is connected to the connector 190. The inner insulative member 185 can include a first plurality of slots 800 and a second plurality of slots 805. The first plurality of slots 800 can include two or more slots 810. The slots 810 can be slots, openings, apertures, spaces formed in and the inner insulative member 185. Each of the first plurality of slots 800 can receive a tab of an electrode layer stack, such as the first tab 155 of the first electrode layer stack 140 or the second tab 160 of the first electrode layer stack 140. As noted above, the first tab 155 of the first electrode layer stack 140 can be a thin foil (e.g., sheet, layer, web) extending from the first electrode layer stack 140 for a distance. The first tab 155 or the second tab 160 can include an end 1000 (e.g., a distal end, a distal portion), as depicted in FIG. 10, among others. The end 1000 of the first tab 155 can be woven (e.g., snaked, laced) through the first plurality of slots 800 (e.g., through multiple slots 810) and coupled with the connector 190. For example, the first tab 155 can extend from the first electrode layer stack 140, through the first plurality of slots 800, and coupled with the connector 190. By providing the end 1000 of the first tab 155 through the first plurality of slots 800, a tension (e.g., tensile force) applied to the first tab 155 during movement of the electrode layer stack 140 or the battery cell 100 (e.g., as an electric vehicle including the battery cell 100 drives, stops, or otherwise moves) can be reduced. For example, the first plurality of slots 800 can act as a strain relieving device to prevent movement of the first electrode layer stack 140 within the cavity 120 of the housing 115 or with respect to the connector 190 from causing a direct tensile force from being applied to the first tab 155. The first plurality of slots 800 can distribute a force applied to the first tab 155 during movement of the first electrode layer stack 140 with respect to the connector 190 to reduce a magnitude of a force applied to single point or area of the first tab 155 (e.g., an area where the first tab 155 is coupled with the first electrode layer stack 140 or with the connector 190.

The second plurality of slots 805 can include two or more slots 810. The slots 810 can be slots, openings, apertures, spaces formed in and the inner insulative member 185. Each of the second plurality of slots 805 can receive a tab of an electrode layer stack, such as the first tab 175 of the second electrode layer stack 170 or the second tab 180 of the second electrode layer stack 170. As noted above, the first tab 175 of the second electrode layer stack 170 can be a thin foil (e.g., sheet, layer, web) extending from the second electrode layer stack 170 for a distance. The first tab 175 or the second tab 180 can include an end 1005 (e.g., a distal end, a distal portion), as depicted in FIG. 10, among others. The end 1005 of the first tab 175 can be woven (e.g., snaked, laced) through the second plurality of slots 805 (e.g., through multiple slots 810) and coupled with the connector 190. For example, the first tab 175 can extend from the second electrode layer stack 170, through the second plurality of slots 805, and coupled with the connector 190. By providing the end 1005 of the first tab 175 through the second plurality of slots 805, a tension (e.g., tensile force) applied to the first tab 175 during movement of the second electrode layer stack 170 or the battery cell 100 (e.g., as an electric vehicle including the battery cell 100 drives, stops, or otherwise moves) can be reduced. For example, the second plurality of slots 805 can act as a strain relieving device to prevent movement of the second electrode layer stack 170 within the cavity 120 of the housing 115 or a movement of the second electrode layer stack 170 with respect to the connector 190 from causing a direct tensile force from being applied to the first tab 175. The second plurality of slots 805 can distribute a force applied to the first tab 175 during movement of the second electrode layer stack 170 with respect to the connector 190 to reduce a magnitude of a force applied to single point or area of the first tab 175 (e.g., an area where the first tab 175 is coupled with the second electrode layer stack 170 or with the connector 190).

The battery cell 100 can include the first tab 155 of the first electrode layer stack 140 extending through the first plurality of slots 800 to couple with the connector 190. For example, the end 1000 of the first tab 155 can extend through the first plurality of slots 800 to couple with the first portion 400 of the connector 190. The end 1000 can extend through the first slot 810 of the first plurality of slots 800 in the first direction 910, extend through the second slot 810 of the first plurality of slots 800 in the second direction 915, and extend through the third slot 810 of the first plurality of slots 800 in the first direction 910. The first tab 155 can bend or flex around the inner insulative member 185 such that the first tab 155 is woven, snaked, laced, or fed through the first slot 810, second slot 810, and third slot 810. The first tab 155 can be provided through more than three slots 810 of the first plurality of slots 800. For example, the first tab 155 of the second electrode layer stack 170 can be provided through five slots 810, seven slots 810, or some other number of slots 810. The end 1000 of the first tab 155 can be coupled with the first portion 400 of the connector 190 with the first tab 155 extending through at least one of the slots 810 of the second plurality of slots 805. The inner insulative member 185 can reduce or substantially prevent (e.g., prevent ±80%) of a tension or tensile force applied to a particular point or area on the first tab 155. For example, the inner insulative member 185 can reduce the likelihood that the first tab 155 will tear, rip, or detach from the first electrode layer stack 140 or the first portion 400 of the connector 190. The inner insulative member 185 can reduce the likelihood that the first tab 155 will electrically decouple from (e.g., lose electrical contact with) the first tab 175 of the second electrode layer stack 170.

The battery cell 100 can include the first tab 175 of the second electrode layer stack 170 extending through the second plurality of slots 805 to couple with the connector 190. For example, the end 1005 of the first tab 175 can extend through the second plurality of slots 805 to couple with the second portion 405 of the connector 190. The end 1005 can extend through the first slot 810 of the second plurality of slots 805 in the first direction 910, extend through the second slot 810 of the second plurality of slots 805 in the second direction 915, and extend through the third slot 810 of the second plurality of slots 805 in the first direction 910. The first tab 175 can bend or flex around the inner insulative member 185 such that the first tab 175 is woven, snaked, laced, or fed through the first slot 810, second slot 810, and third slot 810. The second tab 180 can be provided through more than three slots 810 of the second plurality of slots 805. For example, the first tab 175 of the second electrode layer stack 170 can be provided through five slots 810, seven slots 810, or some other number of slots 810. The end 1005 of the first tab 175 can be coupled with the second portion 405 of the connector 190 with the first tab 175 extending through at least one of the slots 810 of the second plurality of slots 805. The inner insulative member 185 can reduce or substantially prevent (e.g., prevent ±80%) of a tension or tensile force applied to a particular point or area on the first tab 175. For example, the inner insulative member 185 can reduce the likelihood that the first tab 175 will tear, rip, or detach from the second electrode layer stack 170 or the second portion 405 of the connector 190. The inner insulative member 185 can reduce the likelihood that the first tab 175 will electrically decouple from (e.g., lose electrical contact with) the first tab 155 of the first electrode layer stack 140.

The battery cell 100 can include the second tab 160 of the first electrode layer stack 140 extending through the first plurality of slots 800 to couple with the first terminal 105. For example the second tab 160 of the first electrode layer stack 140 can include an end 900, as depicted in FIG. 9, among others. The end 900 of the second tab 160 can extend through the first plurality of slots 800. For example, the end 900 can extend through the first slot 810 of the first plurality of slots 800 in the second direction 915, extend through the second slot 810 of the first plurality of slots 800 in the first direction 910, and extend through the third slot 810 of the first plurality of slots 800 in the second direction 915. The second tab 160 can bend or flex around the inner insulative member 185 such that the second tab 160 is woven, snaked, laced, or fed through the first slot 810, second slot 810, and third slot 810. The second tab 160 can be provided through more than three slots 810 of the first plurality of slots 800. For example, the second tab 160 of the first electrode layer stack 140 can be provided through five slots 810, seven slots 810, or some other number of slots 810. The end 900 of the second tab 160 can be coupled with the first terminal 105 with the second tab 160 extending through at least one of the slots 810 of the first plurality of slots 800. The inner insulative member 185 can reduce or substantially prevent (e.g., prevent ±80%) of a tension or tensile force applied to a particular point or area on the second tab 160. The inner insulative member 185 can reduce the likelihood that the second tab 160 will tear, rip, or detach from the first electrode layer stack 140 or the first terminal 105.

The battery cell 100 can include the second tab 180 of the second electrode layer stack 170 to extend through the second plurality of slots 805 to couple with the second terminal 110. For example, the second tab 180 of the second electrode layer stack 170 can include an end 905, as depicted in FIG. 9, among others. The end 905 of the second tab 180 can extend through the second plurality of slots 805. For example, the end 905 can extend through the first slot 810 of the second plurality of slots 805 in the second direction 915, extend through the second slot 810 of the second plurality of slots 805 in the first direction 910, and extend through the third slot 810 of the second plurality of slots 805 in the second direction 915. The second tab 180 can bend or flex around the inner insulative member 185 such that the second tab 180 is woven, snaked, laced, or fed through the first slot 810, second slot 810, and third slot 810. The second tab 180 can be provided through more than three slots 810 of the second plurality of slots 805. For example, the second tab 180 of the second electrode layer stack 170 can be provided through five slots 810, seven slots 810, or some other number of slots 810. The end 905 of the second tab 180 can be coupled with the second terminal 110 with the second tab 180 extending through at least one of the slots 810 of the second plurality of slots 805. The inner insulative member 185 can reduce or substantially prevent (e.g., prevent ±80%) of a tension or tensile force applied to a particular point or area on the second tab 180. The inner insulative member 185 can reduce the likelihood that the second tab 180 will tear, rip, or detach from the second electrode layer stack 170 or the second terminal 110.

The battery cell 100 can include at least one outer insulative member 195. For example, the outer insulative member 195 can be positioned between the connector 190 and the housing 115. The outer insulative member 195 can have a prismatic form factor (e.g., a height, width, and thickness), a cylindrical form factor (e.g., a thickness and a radius or diameter), or some other form factor. For example, if the housing 115 includes a prismatic form factor, the outer insulative member 195 can include a prismatic form factor having a cross-sectional shape similar to a cross-sectional shape of the housing 115 such that the outer insulative member 195 fits within the cavity 120 of the housing and is proximate to (e.g., within one centimeter of, within three centimeters of, or within some other distance of) the sides 135 of the housing 115. If the housing 115 includes a cylindrical form factor, the outer insulative member 195 can include a form factor having a cylindrical form factor having a cylindrical cross-sectional shape similar to a cylindrical cross-sectional shape of the housing 115 such that the outer insulative member 195 fits within the cavity 120 of the housing 115 and is proximate to (e.g., within one centimeter of, within three centimeters of, within some other distance of) the sides 135 of the housing 115.

The battery cell 100 can include the outer insulative member 195 to insulate the connector 190 from the housing 115. For example, the outer insulative member 195 can be positioned between the connector 190 and the second wall 130 of the housing 115 within the cavity 120. The outer insulative member 195 can be positioned between the connector 190 and the second wall 130 of the housing 115 to prevent the connector 190 from contacting (e.g., touching, impacting) the second wall 130 of the housing 115. For example, the outer insulative member 195 can mechanically insulate the connector 190 from the housing 115 such that the connector 190 or the housing 115 do not contact each other as the first electrode layer stack 140, the second electrode layer stack 170, some other electrode layer stack (e.g., the third electrode layer stack 700), or the connector 190 move relative to the housing 115 (e.g., as the battery cell 100 moves during operation of an electric vehicle). The outer insulative member 195 can electrically insulate the connector 190 from the second wall 130 of the housing 115. For example, the outer insulative member 195 can be a sheet or layer of electrically insulative material, such as Polypropylene, Polyethylene terephthalate, Polyimide, or polymer materials with comparable electrical insulation property and thermal, chemical, or mechanical stability to those listed materials. The outer insulative member 195 can prevent an electrical connection, electrical interference, or some other electrical phenomenon from occurring between the connector 190 and the housing 115.

The battery cell 100 can include the outer insulative member 195 insulate the first terminal 105 or the second terminal 110 from the housing 115. For example, the outer insulative member 195 can be positioned between the first terminal 105 and the first wall 125 of the housing 115 within the cavity 120. The outer insulative member 195 can be positioned between the second terminal 110 the second wall 130 of the housing 115 to prevent the connector 190 from contacting (e.g., touching, impacting) the second wall 130 of the housing 115. For example, the outer insulative member 195 can mechanically insulate the connector 190 from the housing 115 such that the connector 190 or the housing 115 do not contact each other as the first electrode layer stack 140, the second electrode layer stack 170, some other electrode layer stack (e.g., the third electrode layer stack 700), or the connector 190 move relative to the housing 115 (e.g., as the battery cell 100 moves during operation of an electric vehicle). The outer insulative member 195 can electrically insulate the connector 190 from the second wall 130 of the housing 115. For example, the outer insulative member 195 can be a sheet or layer of electrically insulative material, such as Polypropylene, Polyethylene terephthalate, Polyimide, or polymer materials with comparable electrical insulation property and thermal, chemical, or mechanical stability to those listed materials. The outer insulative member 195 can prevent an electrical connection, electrical interference, or some other electrical phenomenon from occurring between the connector 190 and the housing 115.

The battery cell 100 can include a third electrode layer stack 700. For example, the third electrode layer stack 700 can include at least one electrode layer 145, at least one electrode layer 146, at least one separator layer 147, at least one current collector layer 150, and at least one current collector layer 153. The third electrode layer stack 700 can have an operational voltage. For example, the third electrode layer stack 700 can include an operational voltage of less than 3V, approximately 3V (e.g., 2.8V-3.2V, or greater than 3V (e.g., 3.6V, 3.65V, or some other value). The third electrode layer stack 700 can include an operational voltage between 3.2V and 3.65V.

The battery cell 100 can include the third electrode layer stack 700 including a first tab 705 and a second tab 710. For example, the first tab 705 and the second tab 710 can be electrically coupled with at least one of the current collector layers 150 or current collector layers 153 of the third electrode layer stack 700. The first tab 705 and the second tab 710 can extend from (e.g., protrude from) the third electrode layer stack 700 as to be accessible from an exterior of the third electrode layer stack 700. The first tab 705 and the second tab 710 can facilitate the electrical coupling of the third electrode layer stack 700 with another object, device, apparatus, or otherwise. For example, the first tab 705 or the second tab 710 can facilitate the electrical coupling of the third electrode layer stack 700 with a terminal of the battery cell 100 (e.g., the first terminal 105 or the second terminal 110). The first tab 705 or the second tab 710 can facilitate the electrical coupling of the third electrode layer stack 700 to another electrode layer stack (e.g., the second electrode layer stack 170, the first electrode layer stack 140, or some other electrode layer stack).

The battery cell 100 can include third electrode layer stack 700 including the first tab 705 having a first polarity and the second tab 710 having a second polarity. For example, the first tab 705 can include a first polarity (e.g., a cathodic polarity) and the second tab 710 can include a second polarity (e.g., an anodic polarity). The first polarity of the first tab 705 can be different than (e.g., opposite) the second polarity of the second tab 710. The first tab 705 and the second tab 710 can have a material composition corresponding to the respective polarity. For example, the first tab 705 can have a first material composition corresponding to the first polarity. The second tab 710 can have a second material composition correspond to the second polarity. The first tab 705 can include an aluminum-based material composition. The second tab 710 can include a copper-based material composition.

The first tab 705 or the second tab 710 can be integrated with or coupled with a current collector layer 150 or a current collector layer 153 of the third electrode layer stack 700. For example, the first tab 705 or the second tab 710 can be an extension of (e.g., a part of, integrated with) the current collector layer 150 or the current collector layer 153. The first tab 705 or the second tab 710 can be a portion of the current collector layer 150 or the current collector 153 that extends from the third electrode layer stack 700. For example, the current collector layer 153 can extend beyond the electrode layer 146 that is laminated to the current collector layer 153 such that first tab 705 extends beyond the third electrode layer stack 700 as a portion of the current collector layer 153. The current collector layer 150 can extend beyond the electrode layer 145 that is laminated to the current collector layer 150 such that second tab 710 extends beyond the third electrode layer stack 700 as a portion of the current collector layer 150. The first tab 705 or the second tab 710 can be separate from—but coupled to—the current collector layer 150 or the current collector layer 153, respectively. For example, the first tab 705 or the second tab 710 can be welded to, adhered to, or otherwise coupled to the current collector layer 150 or the current collector layer 153. The first tab 705 can include a material composition similar to the current collector layer 153 to which it is coupled or with which it is integrated. For example, the first tab 705 can include a copper-based material composition with the current collector layer 153 laminated with an anodic electrode layer (e.g., an electrode layer 146 having an anodic or first polarity). The second tab 710 can include a material composition similar to the current collector layer 150 to which it is coupled or with which it is integrated. For example, the second tab 710 can include an aluminum-based material composition with the current collector layer 150 laminated with a cathodic electrode layer (e.g., an electrode layer 145 having a cathodic or second polarity).

The battery cell 100 can include the third electrode layer stack 700 electrically coupled with the second electrode layer stack 170. For example, the battery cell 100 can include the first tab 705 of the third electrode layer stack 700 can be electrically coupled with the second tab 180 of the second electrode layer stack 170. Electricity can be conducted between the second electrode layer stack 170 and the third electrode layer stack 700 with the first tab 705 of the third electrode layer stack 700 electrically coupled with the second tab 180 of the second electrode layer stack 170. The first tab 705 of the third electrode layer stack 700 can contact the second tab 180 of the second electrode layer stack 170 such that electricity can be conducted from the first tab 705 to the second tab 180 or from the second tab 180 to the first tab 705. For example, the first tab 705 of the third electrode layer stack 700 can be joined with the second tab 180 of the second electrode layer stack 170 via one or more joining methods. The first tab 705 of the third electrode layer stack 700 can be welded to, friction welded to, clamped to, adhered to, or otherwise joined with the second tab 180 of the second electrode layer stack 170. The first tab 705 of the third electrode layer stack 700 can be coupled with a first portion 400 of a connector, and the second tab 180 of the second electrode layer stack 170 can be coupled with a second portion 405 of the connector 190. The first tab 705 of the third electrode layer stack 700 can be electrically coupled with the second tab 180 of the second electrode layer stack 170 by coupling the first portion 400 of the connector 190 to the second portion 405.

The first tab 705 of the third electrode layer stack 705 can be electrically coupled with the second tab 180 of the second electrode layer stack 170 with the first tab 705 having a polarity that differs from the second tab 180. For example, the first tab 705 of the third electrode layer stack 700 can include a second polarity (e.g., an anodic polarity) and the second tab 180 of the second electrode layer stack 170 can include a first polarity (e.g., a cathodic polarity). The third electrode layer stack 700 and the second electrode layer stack 170 can be electrically coupled in a series configuration with the first tab 705 of the third electrode layer stack 700 electrically coupled with the second tab 180 of the second electrode layer stack 170 where the first tab 705 of the third electrode layer stack 700 includes a second polarity and the second tab 180 of the second electrode layer stack 170 includes a first polarity.

The battery cell 100 can include the second tab 710 of the third electrode layer stack 700 electrically coupled with the second terminal 110. For example, the second tab 710 of the third electrode layer stack 700 can be electrically coupled with the second terminal 110 of the battery cell 100. Electricity can be conducted between the second terminal 110 and the third electrode layer stack 700 with the second terminal 110 electrically coupled with the second tab 710. For example, a device or system can be coupled with the second terminal 110. The second terminal 110 can be coupled with a system of an electric vehicle, such as an electric motor, a charging system, a computing system, or some other system or device. The second tab 710 can include a first polarity. The second terminal 110 can include a first polarity. For example, the polarity of the second tab 710 can be the same as the polarity of the second terminal 110. The polarity of the second tab 710 can be different than (e.g., opposite) the polarity of the second terminal 110.

The battery cell 100 can include an operating voltage that is greater than an operating voltage of the first electrode layer stack 140, the second electrode layer stack 170, or the third electrode layer stack 700. For example, the battery cell 100 can include the first electrode layer stack 140, the second electrode layer stack 170, and the third electrode layer stack 700 electrically coupled in a series configuration. The operating voltage of the battery cell 100 can be approximately equal to (e.g., ±95%) the sum of the operating voltage of the first electrode layer stack (e.g., 3.2V-3.65V), the operating voltage of the second electrode layer stack 170 (e.g., 3.2V-3.65V), and the operating voltage of the third electrode layer stack 700 (e.g., 3.2V-3.65V). For example, the operating voltage of the battery cell can be 9.6V-10.95V with the first electrode layer stack 140, the second electrode layer stack 170, and the third electrode layer stack 700 electrically coupled in a series configuration. The operating voltage of the battery cell 100 can be greater than the operating voltage of the first electrode layer stack 140 or the second electrode layer stack 170 to support various operations or systems. For example, the operating voltage of the battery cell 100 can be greater than the operating voltage of the first electrode layer stack 140 or the second electrode layer stack 170 to support a DC fast-charging application of an electric vehicle or a similar operation.

The battery cell 100 can include more than three electrode layer stacks. For example, the battery cell 100 can include the first electrode layer stack 140 coupled with the second electrode layer stack 170, the second electrode layer stack 170 coupled with the third electrode layer stack 700, and the third electrode layer stack 700 coupled with a fourth electrode stack. The fourth electrode stack can be coupled with a fifth electrode layer stack, and the fifth electrode layer stack can be coupled with additional electrode layer stacks. Each of the electrode layer stacks can be electrically coupled in a series configuration. A first plurality of electrode layer stacks can be electrically coupled in a series configuration such that an operational voltage of the coupled first plurality of electrode layer stacks can be greater than an operational voltage of a single electrode layer stack. A second plurality of electrode layer stack can be electrically coupled in a series configuration such that an operational voltage of the coupled second plurality electrode layer stacks can be greater than an operational voltage of a single electrode layer stack. The first plurality of electrode layer stacks can be electrically coupled with the second plurality of electrode layer stacks in a series configuration such that each of the electrode layer stacks within the battery cell 100 are in a series configuration. The first plurality of electrode layer stacks can be electrically coupled with the second plurality of electrode layer stacks in a parallel configuration such that an operational voltage of the battery cell 100 can be greater than an operational voltage of an individual electrode layer stack and an operational current of the battery cell 100 can be greater than an operational current of an individual electrode layer stack.

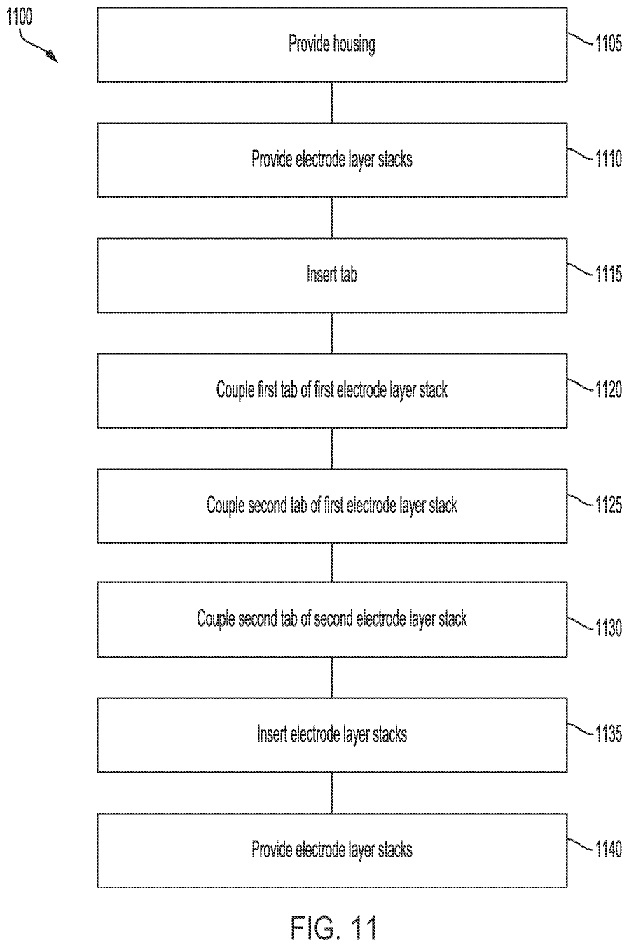

FIG. 11, among others, depicts a method 1100. The method 1100 can include one or more of ACTS 1105-1145. The method 1100 can be performed by an individual (e.g., an operator), a machine (e.g., a robotic assembly machine), or some other system. Each of the ACTS 1105-1145 can be optional. The order of ACTS 1105-1145 can be different than that depicted in FIG. 11 and as described below.

The method 1100 can include providing a housing at ACT 1105. For example, the method 1100 can include providing the housing 115. The housing 115 can define a cavity 120, a sidewall 135, a first wall 125, and a second wall 130. The housing 115 can include a prismatic form factor, a cylindrical form factor, or some other form factor. The housing 115 can receive two or more electrode layer stacks (e.g., the first electrode layer stack 140 and the second electrode layer stack 170). The housing 115 can include or be coupled with a first terminal 105 and a second terminal 110. The first terminal 105 and the second terminal 110 can carry electrical current from the battery cell 100 to an electrical load, such as a component or system of an electric vehicle (e.g., the electric vehicle 1205).

The method 1100 can include providing two or more electrode layer stacks at ACT 1110. For example, the method 1100 can include providing a first electrode layer stack 140 and a second electrode layer stack 170. The first electrode layer stack 140 can include a first tab 155 and a second tab 160. The first tab 155 can include a first polarity (e.g., a positive polarity, an anodic polarity). The second tab 160 can include a second polarity (e.g., a negative polarity, a cathodic polarity) that is different from the first polarity of the first tab 155. The second electrode layer stack 170 can include a first tab 175 and a second tab 180. The first tab 175 can include a second polarity (e.g., a negative polarity, a cathodic polarity). The second tab 180 can include a first polarity (e.g., a positive polarity, an anodic polarity) that is different from the second polarity of the first tab 175.

The method 1100 can include inserting a tab at ACT 1115. For example, the method 1100 can include inserting a tab of an electrode layer stack into (e.g., through) at least one slot or opening of an insulative member. The battery cell 100 can include the inner insulative member 185. The inner insulative member 185 can define a first plurality of slots 800 and a second plurality of slots 805. The first plurality of slots 800 can include two or more slots 810. The second plurality of slots 805 can include two or more slots 810. The method 1100 can include inserting the first tab 155 of the first electrode layer stack 140 into at least one slot 810 of the first plurality of slots 800 of the inner insulative member 185. The method 1100 can include inserting the second tab 160 of the first electrode layer stack 140 into at least one slot 810 of the first plurality of slots 800 of the inner insulative member 185. The method 1100 can include inserting the first tab 175 of the second electrode layer stack 170 into at least one slot 810 of the second plurality of slots 805 of the inner insulative member 185. The method 1100 can include inserting the second tab 180 of the second electrode layer stack 170 into at least one slot 810 of the second plurality of slots 805 of the inner insulative member 185.

The method 1100 can include coupling the first tab 155 of the first electrode layer stack 140 at ACT 1120. For example, the method 1100 can include coupling the first tab 155 of the first electrode layer stack 140 with the connector 190. The connector 190 can include the first portion 400 and the second portion 405. The first tab 155 can be coupled with the first portion 400 of the connector 190. The first tab 155 can be electrically coupled with the first portion 400 such that electricity can be conducted from the first tab 155 to the first portion 400 or vice versa. The first tab 155 can be coupled with the first portion 400 via a joining method, such as welding, friction welding, electrically conductive adhesive, or some other method. The first tab 155 can be coupled with the first portion 400 with the first tab 155 inserted through the inner insulative member 185. For example, the first tab 155 can extend from the first electrode layer stack 140 through at least one slot 810 of the inner insulative member 185, and couple with the first portion 400 of the connector 190.

The method 1100 can include coupling the second tab 160 of the first electrode layer stack 140 at ACT 1125. For example, the method 1100 can include coupling the second tab 160 of the first electrode layer stack 140 with the first terminal 105 of the battery cell 100. The first terminal 105 can be coupled with or integrated with the housing 115. The second tab 160 of the first electrode layer stack 140 can be coupled with the first terminal 105 to electrically couple the first electrode layer stack 140 with the first terminal 105. For example, electricity can be conducted via from the first electrode layer stack 140 through the first terminal 105 and to another system or device (e.g., a system of an electric vehicle) coupled with the first terminal 105. The second tab 160 can be joined to the first terminal 105 via welding, friction welding, electrically conductive adhesive, or some other joining method. The second tab 160 can be coupled with the first terminal 105 with the second tab 160 inserted through the inner insulative member 185. For example, the second tab 160 can extend from the first electrode layer stack 140 through at least one slot 810 of the inner insulative member 185, and couple with the first terminal 105.

The method 1100 can include coupling the first tab 175 of the second electrode layer stack 170 at ACT 1130. For example, the method 1100 can include coupling the first tab 175 of the second electrode layer stack 170 with the connector 190. The connector 190 can include the first portion 400 and the second portion 405. The first tab 175 can be coupled with the second portion 405 of the connector 190. The first tab 175 can be electrically coupled with the second portion 405 such that electricity can be conducted from the first tab 175 to the second portion 405 or vice versa. The first tab 175 can be coupled with the second portion 405 via a joining method, such as welding, friction welding, electrically conductive adhesive, or some other method. The first tab 175 can be coupled with the second portion 405 with the first tab 175 inserted through the inner insulative member 185. For example, the first tab 175 can extend from the second electrode layer stack 170 through at least one slot 810 of the inner insulative member 185, and couple with the second portion 405 of the connector 190.

The method 1100 can include coupling the second tab 180 of the second electrode layer stack 170 at ACT 1135. For example, the method 1100 can include coupling the second tab 180 of the second electrode layer stack 170 with the first terminal 105 of the battery cell 100. The first terminal 105 can be coupled with or integrated with the housing 115. The second tab 160 of the first electrode layer stack 140 can be coupled with the first terminal 105 to electrically couple the first electrode layer stack 140 with the first terminal 105. For example, electricity can be conducted via from the first electrode layer stack 140 through the first terminal 105 and to another system or device (e.g., a system of an electric vehicle) coupled with the first terminal 105. The second tab 160 can be joined to the first terminal 105 via welding, friction welding, electrically conductive adhesive, or some other joining method. The second tab 160 can be coupled with the first terminal 105 with the second tab 160 inserted through the inner insulative member 185. For example, the second tab 160 can extend from the first electrode layer stack 140 through at least one slot 810 of the inner insulative member 185, and couple with the first terminal 105.

The method 1100 can include inserting the electrode layer stacks at ACT 1140. For example, the method 1100 can include inserting the first electrode layer stack 140 into a first insulative pouch 165. The method can include inserting the second electrode layer stack 170 into a second insulative pouch 165. For example, the first insulative pouch 165 and the second insulative pouch 165 can be or include an electrically insulative material to electrically insulate the first electrode layer stack 140 from the second electrode layer stack 170. The first insulative pouch 165 can electrically insulate the first electrode layer stack 140 from the second electrode layer stack 170 and the housing 115. The second insulative pouch 165 can electrically insulate the second electrode layer stack 170 from the first electrode layer stack 140 and the housing. The first insulative pouch 165 and the second insulative pouch 165 can be flexible (e.g., pliable, malleable, non-rigid) or can be rigid (e.g., hard, non-flexible). The first insulative pouch 165 and the second insulative pouch 165 can include at least one opening. For example, the first insulative pouch 165 and the second insulative pouch 165 can include an opening to allow the first tab 155 or the first tab 175 to exit the insulative pouch 165 to make an electrical connection with the first tab 175 or the first tab 155, respectively. The first insulative pouch 165 and the second insulative pouch 165 can include an opening to allow the second tab 160 or the second tab 180 to exit the insulative pouch 165 to make an electrical connection with the first terminal 105 or the second terminal 110, respectively.

The method 1100 can include providing the electrode layer stacks at ACT 1145. For example, the method 1100 can include providing the first electrode layer stack 140 and the second electrode layer stack 170 to the cavity 120 of the housing 115. The method 1100 can include providing the first electrode layer stack 140 and the second electrode layer stack 170 to the cavity 120 of the housing 115 with the first tab 155 of the first electrode layer stack 140 coupled with the first tab 175 of the second electrode layer stack 170. The first electrode layer stack 140 and the second electrode layer stack 170 can be electrically coupled in a series configuration with the first electrode layer stack 140 and the second layer stack 170 positioned within the housing 115.

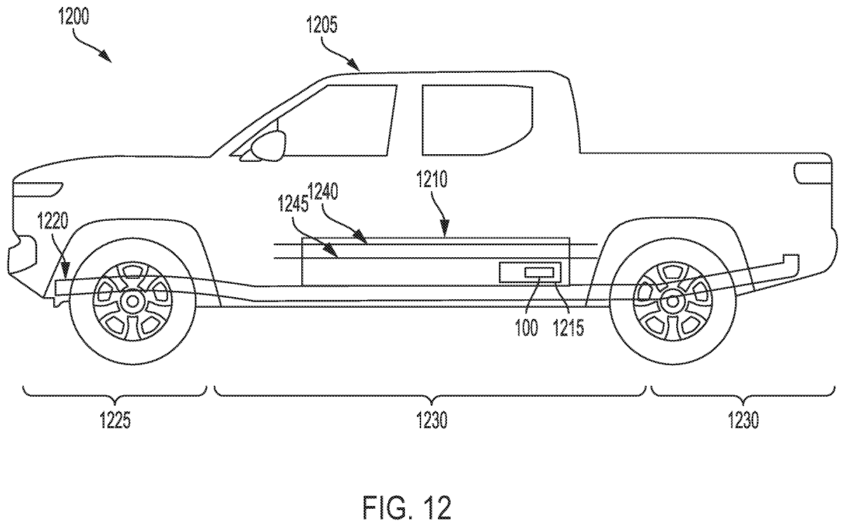

FIG. 12 depicts an example cross-sectional view 1200 of an electric vehicle 1205 installed with at least one battery pack 1210. Electric vehicles 1205 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 1210 can also be used as an energy storage system to power a building, such as a residential home or commercial building. Electric vehicles 1205 can be fully electric or partially electric (e.g., plug-in hybrid) and further, electric vehicles 1205 can be fully autonomous, partially autonomous, or unmanned. Electric vehicles 1205 can also be human operated or non-autonomous. Electric vehicles 1205 such as electric trucks or automobiles can include on-board battery packs 1210, battery modules 1215, or battery cells 100 to power the electric vehicles. The electric vehicle 1205 can include a chassis 1220 (e.g., a frame, internal frame, or support structure). The chassis 1220 can support various components of the electric vehicle 1205. The chassis 1220 can span a front portion 1225 (e.g., a hood or bonnet portion), a body portion 1230, and a rear portion 1235 (e.g., a trunk, payload, or boot portion) of the electric vehicle 1205. The battery pack 1210 can be installed or placed within the electric vehicle 1205. For example, the battery pack 1210 can be installed on the chassis 1220 of the electric vehicle 1205 within one or more of the front portion 1225, the body portion 1230, or the rear portion 1235. The battery pack 1210 can include or connect with at least one busbar, e.g., a current collector element. For example, the first busbar 1240 and the second busbar 1245 can include electrically conductive material to connect or otherwise electrically couple the battery modules 1215 or the battery cells 100 with other electrical components of the electric vehicle 1205 to provide electrical power to various systems or components of the electric vehicle 1205.

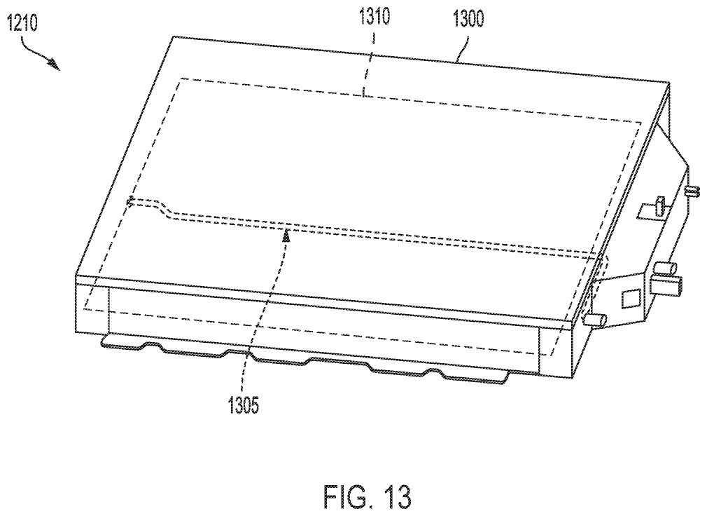

FIG. 13 depicts an example battery pack 1210. Referring to FIG. 13, among others, the battery pack 1210 can provide power to electric vehicle 1205. Battery packs 1210 can include any arrangement or network of electrical, electronic, mechanical or electromechanical devices to power a vehicle of any type, such as the electric vehicle 1205. The battery pack 1210 can include at least one housing 1300. The housing 1300 can include at least one battery module 1215 or at least one battery cell 100, as well as other battery pack components. The battery module 1215 can be or can include one or more groups of prismatic cells, cylindrical cells, pouch cells, or other form factors of battery cells 100. The housing 1300 can include a shield on the bottom or underneath the battery module 1215 to protect the battery module 1215 and/or cells 100 from external conditions, for example if the electric vehicle 1205 is driven over rough terrains (e.g., off-road, trenches, rocks, etc.) The battery pack 1210 can include at least one cooling line 1305 that can distribute fluid through the battery pack 1210 as part of a thermal/temperature control or heat exchange system that can also include at least one thermal component (e.g., cold plate) 1310. The thermal component 1310 can be positioned in relation to a top submodule and a bottom submodule, such as in between the top and bottom submodules, among other possibilities. The battery pack 1210 can include any number of thermal components 1310. For example, there can be one or more thermal components 1310 per battery pack 1210, or per battery module 1215. At least one cooling line 1305 can be coupled with, part of, or independent from the thermal component 1310.

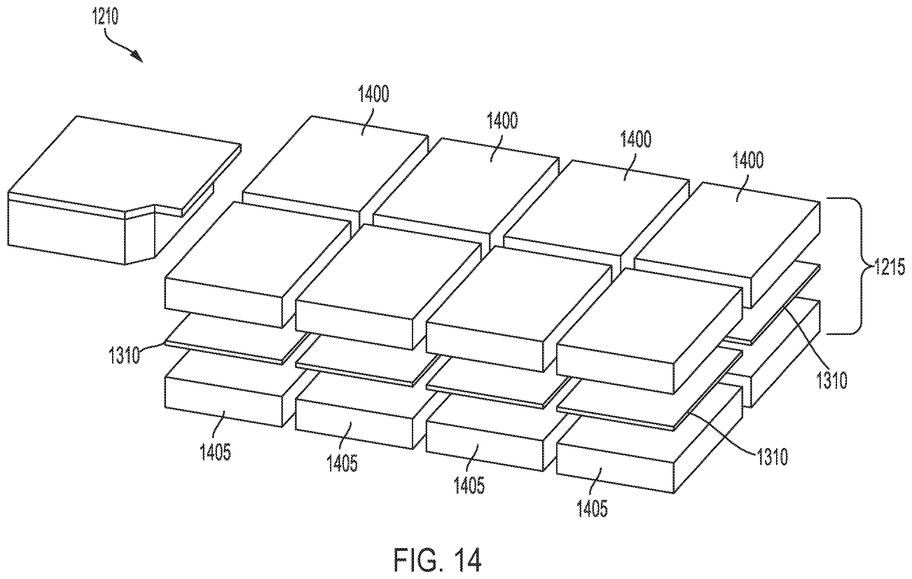

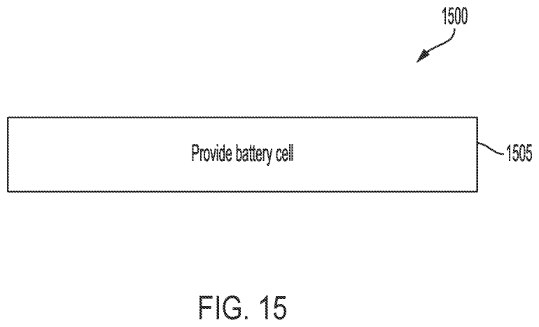

FIG. 14, among others, depicts example battery modules 1215. The battery modules 1215 can include at least one submodule. For example, the battery modules 1215 can include at least one first (e.g., top) submodule 1400 or at least one second (e.g., bottom) submodule 1405. At least one thermal component 1310 can be disposed between the top submodule 1400 and the bottom submodule 1405. For example, one thermal component 1310 can be configured for heat exchange with one battery module 1215. The thermal component 1310 can be disposed or thermally coupled between the top submodule 1400 and the bottom submodule 1405. One thermal component 1310 can also be thermally coupled with more than one battery module 1215 (or more than two submodules 1400, 1405). The thermal components 1310 shown adjacent to each other can be combined into a single thermal component 1310 that spans the size of one or more submodules 1400 or 1405. The thermal component 1310 can be positioned underneath submodule 1400 and over submodule 1405, in between submodules 1400 and 1405, on one or more sides of submodules 1400/1405, among other possibilities. The thermal component 1310 can be disposed in sidewalls, cross members, structural beams, among various other components of the battery pack, such as battery pack 1210 described above. The battery submodules 1400, 1405 can collectively form one battery module 1215. In some examples each submodule 1400, 1405 can be considered as a complete battery module 1215, rather than a submodule.

The battery modules 1215 can each include a plurality of battery cells 100. The battery modules 1215 can be disposed within the housing 1300 of the battery pack 1210. The battery modules 1215 can include battery cells 100 that are cylindrical cells or prismatic cells, for example. The battery module 1215 can operate as a modular unit of battery cells 100. For example, a battery module 1215 can collect current or electrical power from the battery cells 100 that are included in the battery module 1215 and can provide the current or electrical power as output from the battery pack 1210. The battery pack 1210 can include any number of battery modules 1215. For example, the battery pack can have one, two, three, four, five, six, seven, eight, nine, ten, eleven, twelve or other number of battery modules 1215 disposed in the housing 1300. It should also be noted that each battery module 1215 may include a top submodule 1400 and a bottom submodule 1405, possibly with a thermal component 1310 in between the top submodule 1400 and the bottom submodule 1405. The battery pack 1210 can include or define a plurality of areas for positioning of the battery module 1215 and/or cells 100. The battery modules 1215 can be square, rectangular, circular, triangular, symmetrical, or asymmetrical. In some examples, battery modules 1215 may be different shapes, such that some battery modules 1215 are rectangular but other battery modules 1215 are square shaped, among other possibilities. The battery module 1215 can include or define a plurality of slots, holders, or containers for a plurality of battery cells 100. It should be noted the illustrations and descriptions herein are provided for example purposes and should not be interpreted as limiting. For example, the battery cells 100 can be inserted in the battery pack 1210 without battery modules 1400 and 1405. The battery cells 100 can be disposed in the battery pack 1210 in a cell-to-pack configuration without modules 1400 and 1405, among other possibilities.

Battery cells 100 have a variety of form factors, shapes, or sizes. For example, battery cells 100 can have a cylindrical, rectangular, square, cubic, flat, pouch, elongated or prismatic form factor. Battery cells 100 can be assembled, for example, by inserting a winded or stacked electrode roll (e.g., a jelly roll) including electrolyte material into at least one battery cell housing 115. The electrolyte material, e.g., an ionically conductive fluid or other material, can support electrochemical reactions at the electrodes to generate, store, or provide electric power for the battery cell by allowing for the conduction of ions between a positive electrode and a negative electrode. The battery cell 100 can include a separator layer 147 where the separator layer 147 can be or include solid electrolyte material that can conduct ions. For example, the solid electrolyte layer can conduct ions without receiving a separate liquid electrolyte material. The electrolyte material, e.g., an ionically conductive fluid or other material, can support conduction of ions between electrodes to generate or provide electric power for the battery cell 100. The housing 115 can be of various shapes, including cylindrical or rectangular, for example. Electrical connections can be made between the electrolyte material and components of the battery cell 100. For example, electrical connections to the electrodes with at least some of the electrolyte material can be formed at two points or areas of the battery cell 100, for example to form a first terminal 105 (e.g., a positive or anode terminal or a negative or cathode terminal) and a second terminal 110 (e.g., a negative or cathode terminal or a positive or anode terminal).

For example, the battery cell 100 can include at least one lithium-ion battery cell. In lithium-ion battery cells, lithium ions can transfer between a positive electrode and a negative electrode during charging and discharging of the battery cell. For example, the battery cell anode can include lithium or graphite, and the battery cell cathode can include a lithium-based oxide material. The separator material (porous polymer materials soaked with electrolyte material or solid electrolyte) can be disposed in the battery cell 100 to separate the anode and cathode from each other and to facilitate transfer of lithium ions between the anode and cathode. It should be noted that battery cell 100 can also take the form of a solid state battery cell developed using solid electrodes and solid electrolytes. Solid electrodes or electrolytes can be or include inorganic solid electrolyte materials (e.g., oxides, sulfides, phosphides, ceramics), solid polymer electrolyte materials, hybrid solid state electrolytes, or combinations thereof. In some embodiments, the solid electrolyte layer can include polyanionic or oxide-based electrolyte material (e.g., Lithium Superionic Conductors (LISICONs), Sodium Superionic Conductors (NASICONs), perovskites with formula ABO₃ (A=Li, Ca, Sr, La, and B=Al, Ti), garnet-type with formula A₃B₂(XO₄)₃ (A=Ca, Sr, Ba and X=Nb, Ta), lithium phosphorous oxy-nitride (LiₓPO_{y}N_{z}). In some embodiments, the solid electrolyte layer can include a glassy, ceramic and/or crystalline sulfide-based electrolyte (e.g., Li₃PS₄, Li₇P₃S₁₁, Li₂S—P₂S₅, Li₂S—B₂S₃, SnS—P₂S₅, Li₂S—SiS₂, Li₂S—P₂S₅, Li₂S—GeS₂, Li₁₀GeP₂S₁₂) and/or sulfide-based lithium argyrodites with formula Li₆PS₅X (X=Cl, Br) like Li₆PS₅Cl). Furthermore, the solid electrolyte layer can include a polymer electrolyte material (e.g., a hybrid or pseudo-solid state electrolyte), for example, polyacrylonitrile (PAN), polyethylene oxide (PEO), polymethyl-methacrylate (PMMA), and polyvinylidene fluoride (PVDF), among others.

The battery cell 100 can be included in battery modules 1215 or battery packs 1210 to power components of the electric vehicle 1205. The battery cell housing 115 can be disposed in the battery module 1215, the battery pack 1210, or a battery array installed in the electric vehicle 1205. The housing 115 can be of any shape, such as cylindrical with a circular, elliptical, or ovular base, among others. The shape of the housing 115 can also be prismatic with a polygonal base. The housing 115 can include other form factors, such as a triangle, a square, a rectangle, a pentagon, and a hexagon, among others. In some embodiments, the battery pack may not include modules. For example, the battery pack can have a cell-to-pack configuration wherein battery cells are arranged directly into a battery pack without assembly into a module.

The battery cell 100 can include at least one anode layer, which can be disposed within the cavity 120 defined by the housing 115. For example, at least one electrode layer 145 or at least one electrode layer 146 of an electrode layer stack (e.g., the first electrode layer stack 140, the second electrode layer stack 170, the third electrode layer stack 700, or some other electrode layer stack) of the battery cell 100 can be an anode layer. The anode layer can include a first redox potential. The anode layer can receive electrical current into the battery cell 100 and output electrons during the operation of the battery cell 100 (e.g., charging or discharging of the battery cell 100). The anode layer can include an active substance. The active substance can include, for example, an activated carbon or a material infused with conductive materials (e.g., artificial or natural Graphite, or blended), lithium titanate (Li₄Ti₅O₁₂), or a silicon-based material (e.g., silicon metal, oxide, carbide, pre-lithiated), or other lithium alloy anodes (Li—Mg, Li—Al, Li—Ag alloy etc.) or composite anodes consisting of lithium and carbon, silicon and carbon or other compounds. The active substance can include graphitic carbon (e.g., ordered or disordered carbon with sp2 hybridization), Li metal anode, or a silicon-based carbon composite anode, or other lithium alloy anodes (Li—Mg, Li—Al, Li—Ag alloy etc.) or composite anodes consisting of lithium and carbon, silicon and carbon or other compounds. In some examples, an anode material can be formed within a current collector material. For example, an electrode can include a current collector (e.g., a copper foil) with an in situ-formed anode (e.g., Li metal) on a surface of the current collector facing the separator or solid-state electrolyte. In such examples, the assembled cell does not comprise an anode active material in an uncharged state.

The battery cell 100 can include at least one cathode layer (e.g., a composite cathode layer compound cathode layer, a compound cathode, a composite cathode, or a cathode). For example, at least one electrode layer 145 or at least one electrode layer 146 of an electrode layer stack (e.g., the first electrode layer stack 140, the second electrode layer stack 170, the third electrode layer stack 700, or another electrode layer stack) of the battery cell 100 can be a cathode layer. The cathode layer can include a second redox potential that can be different than the first redox potential of the anode layer (e.g., another electrode layer 145 or another electrode layer 146 of an electrode layer stack of the battery cell 100). The cathode layer can be disposed within the cavity 120. The cathode layer can output electrical current out from the battery cell 100 and can receive electrons during the discharging of the battery cell 100. The cathode layer can also release lithium ions during the discharging of the battery cell 100. Conversely, the cathode layer can receive electrical current into the battery cell 100 and can output electrons during the charging of the battery cell 100. The cathode layer can receive lithium ions during the charging of the battery cell 100.

The battery cell 100 can include a separator layer disposed within the cavity 120. For example, at least one separator layer 147 of an electrode layer stack (e.g., the first electrode layer stack 140, the second electrode layer stack 170, the third electrode layer stack 700, or another electrode layer stack) of the battery cell 100 can be positioned between an anode layer (e.g., an electrode layer 146 or an electrode layer 145) and a cathode layer (e.g., an electrode layer 145 or an electrode layer 146). The separator layer can be arranged between the anode layer and the cathode layer to separate the anode layer and the cathode layer. The separator layer can be an electrolyte layer. The separator layer can help transfer ions between the anode layer and the cathode layer. The separator layer can transfer Li⁺ cations from the anode layer to the cathode layer during the discharge operation of the battery cell 100. The separator layer can transfer lithium ions from the cathode layer to the anode layer during the charge operation of the battery cell 100.

The redox potential of layers (e.g., the first redox potential of the anode layer or the second redox potential of the cathode layer) can vary based on a chemistry of the respective layer or a chemistry of the battery cell 100. For example, lithium-ion batteries can include an olivine structured material such as LFP (lithium iron phosphate) and LMFP (lithium manganese iron phosphate) chemistry, an layered-structured material such as NMC (Nickel Manganese Cobalt) chemistry, an NCA (Nickel Cobalt Aluminum) chemistry, an LCO (lithium cobalt oxide) chemistry, or spinel structured material such as LMO (lithium manganese oxide) for a cathode layer (e.g., the cathode layer). Lithium-ion batteries can include a graphite chemistry, a silicon-graphite chemistry, or a lithium metal chemistry for the anode layer (e.g., the anode layer).

For example, lithium-ion batteries can include an olivine phosphate (LiMPO₄, M=Fe and/or Co and/or Mn and/or Ni)) chemistry, LISICON or NASICON Phosphates (Li₃M₂(PO₄)₃ and LiMPO₄Oₓ, M=Ti, V, Mn, Cr, and Zr), for example Lithium iron phosphate (LFP), Lithium iron manganese phosphate (LMFP), a layered oxides (LiMO₂, M=Ni and/or Co and/or Mn and/or Fe and/or Al and/or Mg) examples NMC (Nickel Manganese Cobalt) chemistry, an NCA (Nickel Cobalt Aluminum) chemistry, or an LCO (lithium cobalt oxide) chemistry for a cathode layer, Lithium rich layer oxides (Li₁₊ₓM₁₋ₓO₂) (Ni, and/or Mn, and/or Co), (OLO or LMR), spinel (LiMn₂O₄) and high voltage spinels (LiMn_{1.5}Ni_{0.5}O₄), disordered rock salt, Fluorophosphates Li₂FePO₄F (M=Fe, Co, Ni) and Fluorosulfates LiMSO₄F (M=Co, Ni, Mn) (e.g., the cathode layer 255). Lithium-ion batteries can include a graphite chemistry, a silicon-graphite chemistry, or a lithium metal chemistry for the anode layer (e.g., the anode layer 245). For example, a cathode layer having an LFP chemistry can have a redox potential of 3.4 V vs. Li/Li⁺, while an anode layer having a graphite chemistry can have a 0.2 V vs. Li/Li⁺ redox potential.

Electrode layers can include anode active material or cathode active material, commonly in addition to a conductive carbon material, a binder, other additives as a coating on a current collector (metal foil). The chemical composition of the electrode layers can affect the redox potential of the electrode layers. For example, cathode layers (e.g., the cathode layer) can include medium to high-nickel content (50 to 80%, or equal to 80% Ni) lithium transition metal oxide, such as a particulate lithium nickel manganese cobalt oxide (“LiNMC”), a lithium nickel cobalt aluminum oxide (“LiNCA”), a lithium nickel manganese cobalt aluminum oxide (“LiNMCA”), or lithium metal phosphates like lithium iron phosphate (“LFP”) and Lithium iron manganese phosphate (“LMFP”). Anode layers (e.g., the anode layer) can include conductive carbon materials such as graphite, carbon black, carbon nanotubes, and the like. Anode layers can include Super P carbon black material, Ketjen Black, Acetylene Black, SWCNT, MWCNT, graphite, carbon nanofiber, or graphene, for example.

Electrode layers can also include chemical binding materials (e.g., binders). Binders can include polymeric materials such as polyvinylidenefluoride (“PVDF”), polyvinylpyrrolidone (“PVP”), styrene-butadiene or styrene-butadiene rubber (“SBR”), polytetrafluoroethylene (“PTFE”) or carboxymethylcellulose (“CMC”). Binder materials can include agar-agar, alginate, amylose, Arabic gum, carrageenan, caseine, chitosan, cyclodextrines (carbonyl-beta), ethylene propylene diene monomer (EPDM) rubber, gelatine, gellan gum, guar gum, karaya gum, cellulose (natural), pectine, poly(3,4-ethylenedioxythiophene) polystyrene sulfonate (PEDOT-PSS), polyacrylic acid (PAA), poly(methyl acrylate) (PMA), poly(vinyl alcohol) (PVA), poly(vinyl acetate) (PVAc), polyacrylonitrile (PAN), polyisoprene (Plpr), polyaniline (PANi), polyethylene (PE), polyimide (PI), polystyrene (PS), polyurethane (PU), polyvinyl butyral (PVB), polyvinyl pyrrolidone (PVP), starch, styrene butadiene rubber (SBR), tara gum, tragacanth gum, fluorine acrylate (TRD202A), xanthan gum, or mixtures of any two or more thereof.

Current collector materials (e.g., a current collector foil to which an electrode active material is laminated to form a cathode layer or an anode layer) can include a metal material. For example, current collector materials can include aluminum, copper, nickel, titanium, stainless steel, or carbonaceous materials. The current collector material can be formed as a metal foil. For example, the current collector material can be an aluminum (Al) or copper (Cu) foil. The current collector material can be a metal alloy, made of Al, Cu, Ni, Fe, Ti, or combination thereof. The current collector material can be a metal foil coated with a carbon material, such as carbon-coated aluminum foil, carbon-coated copper foil, or other carbon-coated foil material.

The separator layer 147 can include or be made of a liquid electrolyte material. For example, the separator layer can be or include at least one layer of polymeric material (e.g., polypropylene, polyethylene, or other material) that is wetted (e.g., is saturated with, is soaked with, receives) a liquid electrolyte substance. The liquid electrolyte material can include a lithium salt dissolved in a solvent. The lithium salt for the liquid electrolyte material for the separator layer 147 can include, for example, lithium tetrafluoroborate (LiBF₄), lithium hexafluorophosphate (LiPF₆), and lithium perchlorate (LiClO₄), among others. The solvent can include, for example, dimethyl carbonate (DMC), ethylene carbonate (EC), and diethyl carbonate (DEC), among others. The separator layer 147 can include or be made of a solid electrolyte material, such as a ceramic electrolyte material, polymer electrolyte material, or a glassy electrolyte material, or among others, or any combination thereof.

In some embodiments, the solid electrolyte film can include at least one layer of a solid electrolyte. Solid electrolyte materials of the solid electrolyte layer can include inorganic solid electrolyte materials (e.g., oxides, sulfides, phosphides, ceramics), solid polymer electrolyte materials, hybrid solid state electrolytes, or combinations thereof. In some embodiments, the solid electrolyte layer can include polyanionic or oxide-based electrolyte material (e.g., Lithium Superionic Conductors (LISICONs), Sodium Superionic Conductors (NASICONs), perovskites with formula ABO₃ (A=Li, Ca, Sr, La, and B=Al, Ti), garnet-type with formula A₃B₂(XO₄)₃ (A=Ca, Sr, Ba and X=Nb, Ta), lithium phosphorous oxy-nitride (LiₓPO_{y}N_{z}). In some embodiments, the solid electrolyte layer can include a glassy, ceramic and/or crystalline sulfide-based electrolyte (e.g., Li₃PS₄, Li₇P₃S₁₁, Li₂S—P₂S₅, Li₂S—B₂S₃, SnS—P₂S₅, Li₂S—SiS₂, Li₂S—P₂S₅, Li₂S—GeS₂, Li₁₀GeP₂S₁₂) and/or sulfide-based lithium argyrodites with formula Li₆PS₅X (X=Cl, Br) like Li₆PS₅Cl). Furthermore, the solid electrolyte layer can include a polymer electrolyte material (e.g., a hybrid or pseudo-solid state electrolyte), for example, polyacrylonitrile (PAN), polyethylene oxide (PEO), polymethyl-methacrylate (PMMA), and polyvinylidene fluoride (PVDF), among others.

In examples where the separator layer 147 includes a liquid electrolyte material, the separator layer 147 can include a non-aqueous polar solvent. The non-aqueous polar solvent can include a carbonate such as ethylene carbonate, propylene carbonate, diethyl carbonate, ethyl methyl carbonate, dimethyl carbonate, or a mixture of any two or more thereof. The separator layer 147 can include at least one additive. The additives can be or include vinylidene carbonate, fluoroethylene carbonate, ethyl propionate, methyl propionate, methyl acetate, ethyl acetate, or a mixture of any two or more thereof. The separator layer 147 can include a lithium salt material. For example, the lithium salt can be lithium perchlorate, lithium hexafluorophosphate, lithium bis(fluorosulfonyl)imide, lithium bis(trifluorosulfonyl)imide, or a mixture of any two or more thereof. The lithium salt may be present in the separator layer 147 from greater than 0 M to about 1.5 M.

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. For example, the first terminal 105 can be a positive or negative terminal and the second terminal 110 can be a negative or positive terminal, respectively. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A battery cell, comprising:
a first electrode layer stack positioned within a housing;
a first tab of the first electrode layer stack;
a second tab of the first electrode layer stack coupled with a first terminal;
a second electrode layer stack positioned within the housing;
a first tab of the second electrode layer stack coupled with the first tab of the first electrode layer stack; and
the first electrode layer stack electrically insulated from the second electrode layer stack.

2. The battery cell of claim 1, comprising:
the second electrode layer stack coupled with a second terminal; and
the first tab of the first electrode layer stack having a first polarity and the first tab of the second electrode layer stack having a second polarity.

3. The battery cell of claim 1, comprising:
the first tab of the first electrode layer stack coupled with the first tab of the first electrode layer stack via a connector, the connector including a first portion and a second portion, the first portion including a tooth, the second portion including a groove, the groove of the second portion to receive the tooth of the first portion to mechanically couple the first portion with the second portion.

4. The battery cell of claim 1, comprising:
the first electrode layer stack and the second electrode layer stack electrically coupled in a series configuration; and
the battery cell including a first operational voltage with the first electrode layer stack and the second electrode layer stack electrically coupled, the first operational voltage being greater than an operational voltage of the first electrode layer stack or the second electrode layer stack.

5. The battery cell of claim 1, comprising:
the housing including a first wall and a second wall, the second tab of the first electrode layer stack coupled with the first terminal proximate the first wall, the second tab of the second electrode layer stack coupled with a second terminal proximate the first wall, and the first tab of the first electrode layer stack coupled with the first tab of the second electrode layer stack proximate the at least one of the first wall and the second wall; and
the first tab of the first electrode layer stack having a first polarity and the first tab of the second electrode layer stack having a second polarity.

6. The battery cell of claim 1, comprising:
the housing including a first wall and a second wall, the second tab of the first electrode layer stack coupled with the first terminal proximate the first wall, the second tab of the second electrode layer stack coupled with a second terminal proximate the first wall, and the first tab of the first electrode layer stack coupled with the first tab of the second electrode layer stack proximate the first wall; and
the first tab of the first electrode layer stack coupled with the first tab of the second electrode layer stack via a busbar connector, the busbar connector including a first portion and a second portion, the first portion including a tooth, the second portion including a groove, the groove of the second portion to receive the tooth of the first portion to mechanically couple the first portion with the second portion.

7. The battery cell of claim 1, comprising:
the housing including a first wall and a second wall, the second tab of the second electrode layer stack coupled with the first terminal proximate the first wall, the second tab of the second electrode layer stack coupled with a second terminal proximate the first wall, and the first tab of the first electrode layer stack coupled with the first tab of the second electrode layer stack proximate the second wall;
the first tab of the first electrode layer stack coupled with the first tab of the second electrode layer stack via a connector, the connector including a first portion and a second portion, the first portion including a tooth, the second portion including a groove, the groove of the second portion to receive the tooth of the first portion to mechanically couple the first portion with the second portion; and
the first tab of the first electrode layer stack having a first polarity and the first tab of the second electrode layer stack having a second polarity.

8. The battery cell of claim 1, comprising:
the first tab of the first electrode layer stack including a first material composition and the first tab of the second electrode layer stack including a second material composition; and
the first tab of the first electrode layer stack coupled with the first tab of the second electrode layer stack via a connector, the connector including a first portion and a second portion, the first portion including a first form factor and the first material composition, the second portion including a second form factor and the second material composition, the first portion mechanically coupled with the second portion.

9. The battery cell of claim 1, comprising:
a third electrode layer stack, the third electrode layer stack including a first tab of the third electrode layer stack and a second tab of the third electrode layer stack, the first tab of the first electrode layer stack coupled with the second tab of the second electrode layer stack, the second tab of the third electrode layer stack coupled with a second terminal, the third electrode layer stack insulated from the first electrode layer stack and the second electrode layer stack;
the first tab of the first electrode layer stack and the first tab of the third electrode layer stack having a first polarity; and
the first tab of the second electrode layer stack having a second polarity.

10. The battery cell of claim 1, comprising:
the first electrode layer stack including a first orientation having the first tab of the first electrode layer stack proximate a first side of the housing the second tab of the first electrode layer stack proximate to a second side of the housing; and
the second electrode layer stack including a second orientation having the first tab of the second electrode layer stack proximate to the second side of the housing and the second tab of the second electrode layer stack proximate the first side of the housing.

11. The battery cell of claim 1, comprising:
the first electrode layer stack including a first orientation having the first tab of the first electrode layer stack proximate to a second wall of the housing and the second tab of the first electrode layer stack proximate to a first wall of the housing;
the second electrode layer stack including the first orientation having the first tab of the second electrode layer stack proximate to the second wall of the housing and the second tab of the second electrode layer stack proximate to the first wall of the housing; and
the first tab of the first electrode layer stack having a first polarity and the first tab of the second electrode layer stack having a second polarity.

12. The battery cell of claim 1, comprising:
a first insulative pouch surrounding the first electrode layer stack to insulate the first electrode layer stack from the housing and the second electrode layer stack; and
a second insulative pouch surrounding the second electrode layer stack to insulate the second electrode layer stack from the housing and the first electrode layer stack.

13. The battery cell of claim 1, comprising:
an insulative member including a first plurality of slots and a second plurality of slots;
the first tab of the first electrode layer stack extending through a first slot of the first plurality of slots in a first direction, through a second slot of the first plurality of slots in a second direction, and through a third slot of the first plurality of slots in the first direction; and
the first tab of the second electrode layer stack extending through a first slot of the second plurality of slots in the first direction, through a second slot of the second plurality of slots in the second direction, and through a third slot of the second plurality of slots in the first direction.

14. The battery cell of claim 1, comprising:
a first insulative pouch surrounding the first electrode layer stack to insulate the first electrode layer stack from the housing and the second electrode layer stack;
a second insulative pouch surrounding the second electrode layer stack to insulate the second electrode layer stack from the housing and the first electrode layer stack;
an insulative member including a first plurality of slots and a second plurality of slots;
the first tab of the first electrode layer stack extending through a first slot of the first plurality of slots in a first direction, through a second slot of the first plurality of slots in a second direction, and through a third slot of the first plurality of slots in the first direction;
the first tab of the second electrode layer stack extending through a first slot of the second plurality of slots in the first direction, through a second slot of the second plurality of slots in the second direction, and through a third slot of the second plurality of slots in the first direction; and
the first tab of the first electrode layer stack coupled with the first tab of the second electrode layer stack via a connector;
wherein the insulative member is positioned between the first electrode layer stack and the connector and between the second electrode layer stack and the connector.

15. A method, comprising:
providing a housing of a battery cell, the housing defining a cavity;
coupling a first tab of a first electrode layer stack with a first tab of a second electrode layer stack;
coupling a second tab of the first electrode layer stack with a first terminal of the battery cell and a second tab of the second electrode layer stack with a second terminal of the battery cell; and
providing the first electrode layer stack and the second electrode layer stack within the cavity.

16. The method of claim 15, comprising:
inserting the first electrode layer stack into a first insulative pouch; and
inserting the second electrode layer stack into a second insulative pouch.

17. The method of claim 15, comprising:
inserting the second tab of the first electrode layer stack through a first plurality of slots of an insulative member; and
inserting the second tab of the second electrode layer stack through a second plurality of slots of the insulative member, the second tab of the first electrode layer stack coupled with the second tab of the second electrode layer stack with the second tab of the first electrode layer stack inserted through the first plurality of slots and the second tab of the second electrode layer stack inserted through the second plurality of slots.

18. The method of claim 15, wherein the first tab of the first electrode layer stack is coupled with the first tab of the second electrode layer stack via a connector, the connector including a first portion and a second portion, the first portion having a first form factor and a first material composition, the second portion having a second form factor and a second material composition, the first portion mechanically coupled with the second portion.

19. A battery pack, comprising:
a plurality of battery cells, wherein at least one of the plurality of battery cells comprises:
a first electrode layer stack positioned within a housing;
a first tab of the first electrode layer stack;
a second tab of the first electrode layer stack coupled with a first terminal;
a second electrode layer stack positioned within the housing;
a first tab of the second electrode layer stack coupled with the first tab of the first electrode layer stack; and
the first electrode layer stack electrically insulated from the second electrode layer stack.

20. The battery pack of claim 19, comprising:
the at least one of the plurality of battery cells including the first tab of the first electrode layer stack coupled with the first tab of the second electrode layer stack via a connector, the connector including a first portion and a second portion, the first portion having a first form factor and a first material composition, the second portion having a second form factor and a second material composition, the first portion mechanically coupled with the second portion.
